(19) United States
(12) Patent Application Publication
(10) Pub. No.: US 2026/0119515 A1
(43) Pub. Date: Apr. 30, 2026

(54) INFORMATION PROCESSING DEVICE, DISPLAY CONTROL METHOD, AND NON-TRANSITORY COMPUTER READABLE MEMORY

(71) Applicant: Rakuten Group, Inc., Tokyo (JP)

(72) Inventors: Mihoko TAROURA, Tokyo (JP); Keita YANAGIMOTO, Tokyo (JP); Sahil JAIN, Tokyo (JP); Shiho YOSHITOMI, Tokyo (JP)

(73) Assignee: Rakuten Group, Inc., Tokyo (JP)

(21) Appl. No.: 19/332,284

(22) Filed: Sep. 18, 2025

(30) Foreign Application Priority Data
Oct. 28, 2024 (JP) 2024-189252

(51) Int. Cl. G06F 16/248; G06F 16/2458; G06F 16/28; G06F 16/951

(52) U.S. Cl. CPC G06F 16/248; G06F 16/2462; G06F 16/287; G06F 16/951

(57) ABSTRACT

A computer architecture for determining and executing statistical processing to determine a display limitation limiting the display of at least a portion of the statistical information based on the data object information in response to a second data object count or third data object count being equal to or less than the first threshold value, or the first data object count being equal to or less than the second threshold value.

### CROSS REFERENCE TO RELATED APPLICATION

This application claims priority from Japanese Patent Application No. 2024-189252 which was filed on Oct. 28, 2024, the disclosure of which is herein incorporated by reference in its entirety.

### Technical Field

One or more embodiments of the present disclosure relate to a technical field such as a system for presenting statistical information based on attributes of a first data object (also referred to herein as “D. O.”) to be analyzed.

### Related Art

Conventionally, a system is known for generating statistical information based on attributes of first data objects to be analyzed, and presenting the generated statistical information to a viewer (e.g., an analyst). For example, JP 2017-534124 A discloses a system for generating and displaying a viewer metric that describes how a first data object's reference group and target group differ in several first data object characteristics).

However, when the statistical information based on the attributes of the first data objects to be analyzed is presented to the viewer, if the number of the first data objects is relatively small, information on the privacy of the first data objects may be estimated or specified to the viewer.

Therefore, one or more embodiments of the present disclosure are to providing a computer architecture, a display control method, and a non-transitory computer readable memory which are capable of more appropriately protecting privileged information associated with data objects when the statistical information based on attributes, etc., of the first data objects to be analyzed is presented to the viewer.

### SUMMARY

(An aspect 1) In response to the above issue, a computer architecture is capable of utilizing a database that stores fourth data object information associated with first information of one or more first data objects registered through a predetermined fourth data object registration procedure, and capable of displaying statistical information based on the fourth data object information on a display device. The computer architecture includes: at least one memory configured to store program code; and at least one processor configured to access the program code and operate as instructed by the program code. The program code includes: information acquisition code configured to cause the at least one processor to acquire second information of one or more second first data objects who can use a predetermined service, the one or more second first data objects including one or more first data objects, in response to a viewing request from a viewer to view the statistical information; fourth data object information acquisition code configured to cause the at least one processor to acquire the fourth data object information of the one or more first data objects included in the one or more second first data objects, based on the first information associated with the fourth data object information stored in the database and the acquired second information; and display control code configured to cause the at least one processor to execute a display limitation processing to limit, on the display device, display of at least a portion of the statistical information based on the acquired fourth data object information, in response to the number of pieces of the acquired second information being equal to or less than a first threshold value, or the number of pieces of the acquired fourth data object information being equal to or less than a second threshold value.

(An aspect 2) A display control method executed by one or more computers includes: accessing a database that stores fourth data object information associated with first information of one or more first data objects registered through a predetermined fourth data object registration procedure; displaying statistical information based on the fourth data object information on a display device; acquiring second information of one or more second first data objects who can use a predetermined service, the one or more second first data objects including one or more first data objects, in response to a viewing request from a viewer to view the statistical information; acquiring the fourth data object information of the one or more first data objects included in the one or more second first data objects, based on the first information associated with the fourth data object information stored in the database and the acquired second information; and executing a display limitation processing to limit, on the display device, display of at least a portion of the statistical information based on the acquired fourth data object information, in response to the number of pieces of the acquired second information being equal to or less than a first threshold value, or the number of pieces of the acquired fourth data object information being equal to or less than a second threshold value.

(An aspect 3) A non-transitory computer-readable memory has stored thereon a program configured to cause a computer to: access a database that stores fourth data object information associated with first information of one or more first data objects registered through a predetermined fourth data object registration procedure; display statistical information based on the fourth data object information on a display device; acquire second information of one or more second first data objects who can use a predetermined service, the one or more second first data objects including one or more first data objects, in response to a viewing request from a viewer to view the statistical information; acquire the fourth data object information of the one or more first data objects included in the one or more second first data objects, based on the first information associated with the fourth data object information stored in the database and the acquired second information; and execute a display limitation processing to limit, on the display device, display of at least a portion of the statistical information based on the acquired fourth data object information, in response to the number of pieces of the acquired second information being equal to or less than a first threshold value, or the number of pieces of the acquired fourth data object information being equal to or less than a second threshold value.

### BRIEF DESCRIPTION OF THE DRAWINGS

FIG. 1 is a diagram illustrating a schematic configuration example of a statistical information providing system S.

FIG. 2 is a diagram illustrating a schematic configuration example of a viewer terminal VT.

FIG. 3 is a diagram illustrating an example of a data source selection screen.

FIG. 4 is a diagram illustrating an example of a statistical information display screen showing statistical information based on fourth data object information.

FIG. 5 is a diagram illustrating an example of a statistical information display screen showing details of statistical information based on fourth data object information.

FIG. 6 is a diagram illustrating an example of a group editing screen.

FIG. 7 is a diagram illustrating an example of a statistical information display screen, showing an example where statistical information on each group within each aggregate group (Group2 and Group3) has been additionally displayed.

FIG. 8 is a diagram illustrating an example of a statistical information display screen, showing an example where statistical information on each group within each aggregate group (Group2 and Group3) has been additionally displayed.

FIG. 9 is a diagram illustrating an example of statistical information being concealed in a Data Coverage Area Ar21 associated with a second data object.

FIG. 10 is a diagram illustrating an example in which statistical information on a group with a total fourth data object count or group fourth data object count being equal to or less than a second threshold value is ambiguously displayed or concealed among a plurality of groups shown in a Demographic Area Ar24.

FIG. 11 is a diagram illustrating a schematic configuration example of a fourth data object information management server SE1.

FIG. 12 is a diagram illustrating a schematic configuration example of a statistical information providing server SE2.

FIG. 13 is a diagram illustrating an example of functional blocks in a control unit 23.

FIG. 14 is a flowchart illustrating an example of statistical information display processing executed by the control unit 23 of a statistical information providing server SE2.

FIG. 15 is a flowchart illustrating an example of statistical information display processing executed by the control unit 23 of the statistical information providing server SE2.

FIG. 16 is a flowchart illustrating an example of regrouping processing in step S25, as shown in FIG. 15.

### DETAILED DESCRIPTION

Hereinbelow, one or more embodiments of the present disclosure will be described with reference to the drawings. The following embodiments are embodiments in a case where the present disclosure is applied to a statistical information providing system.

[1. Configuration and Operation outline of Statistical Information Providing System S]

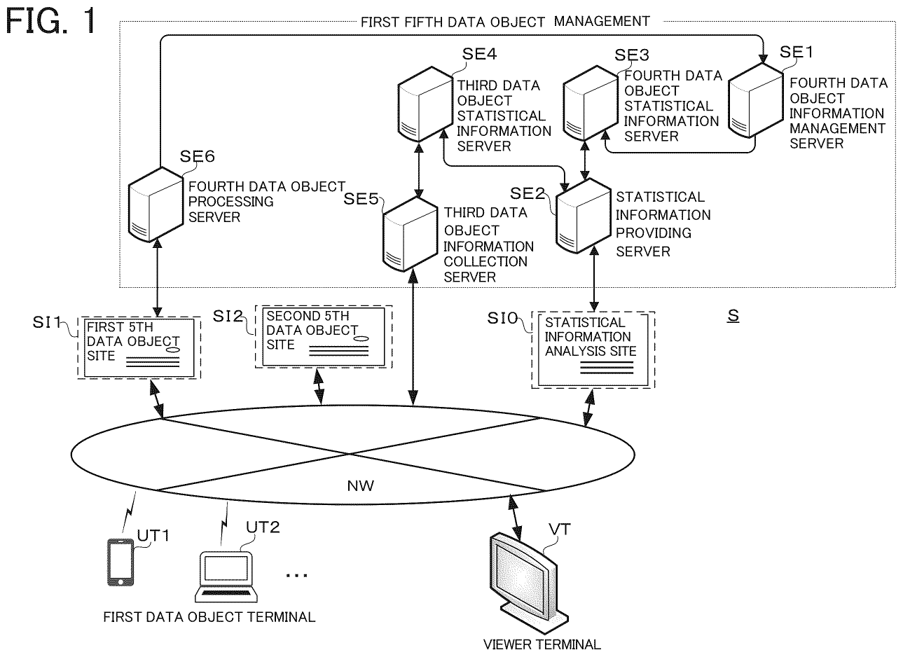

First, a configuration and function outline of a statistical information providing system S according to the present embodiment will be described with reference to FIG. 1. FIG. 1 is a diagram illustrating a schematic configuration example of the statistical information providing system S. As illustrated in FIG. 1, the statistical information providing system S includes a fourth data object information management server SE1, a statistical information providing server SE2 (an example of the computer architecture of the present disclosure), a fourth data object statistical information server SE3, a third data object statistical information server SE4, a third data object information collection server SE5, a fourth data object processing server SE6, and the like. These servers SE1 to SE6 are respectively managed and operated by a first fifth data object (an example of a first provider). The fourth data object information management server SE1 is a server for managing fourth data object information. The statistical information providing server SE2 is a server for providing statistical information based on the fourth data object information. The fourth data object statistical information server SE3 and the third data object statistical information server SE4 are servers for providing the statistical information providing server SE2 with information necessary for generating the statistical information based on the fourth data object information. Incidentally, the statistical information providing server SE2, the fourth data object statistical information server SE3, and the third data object statistical information server SE4 may be configured in the same server computer. In other words, functions of the fourth data object statistical information server SE3, and the third data object statistical information server SE4 may be implemented in the statistical information providing server SE2.

Moreover, the fourth data object information management server SE1 is connected to the fourth data object statistical information server SE3 and the fourth data object processing server SE6, for example, via a dedicated line (i.e., dedicated communication line). Moreover, the statistical information providing server SE2 is connected to the fourth data object statistical information server SE3 and the third data object statistical information server SE4, for example, via a dedicated line. Incidentally, the statistical information providing server SE2 may be connected to the fourth data object information management server SE1, for example, via a dedicated line. Furthermore, the statistical information providing server SE2 may be connected to a statistical information analysis site SI0, for example, via a dedicated line. Moreover, the third data object statistical information server SE4 is connected to the third data object information collection server SE5, for example, via a dedicated line.

Here, the fourth data object information is information on a fourth data object (an example of a first data object) of the first fifth data object. The fourth data object is registered through a predetermined fourth data object registration procedure (e.g., an online procedure via the fourth data object processing server SE6) by the first fifth data object. The fourth data object information includes attribute information indicating attributes (e.g., attributes such as gender, age) of the fourth data object. Moreover, the fourth data object information may include transaction information indicating the history (e.g., purchase history or reservation history) of the fourth data object's transaction in the business (e.g., business related to commercial transaction) of the first fifth data object. Incidentally, the fourth data object information is stored (memorized) in a database in association with a fourth data object ID (an example of first information) for identifying the fourth data object.

The communication network NW includes, for example, the Internet, a mobile communication network, a radio base station thereof, and the like. The statistical information analysis site SI0, a viewer terminal VT, and the third data object information collection server SE5 are connected to the communication network NW. The statistical information analysis site SI0 is the first fifth data object's website and is provided by the first fifth data object's web server and the like. Incidentally, the statistical information providing server SE2 may be connected to the communication network NW. The viewer terminal VT is used by a viewer belonging to a second fifth data object (an example of a second provider) and can access the statistical information analysis site SI0 via the communication network NW.

Here, the second fifth data object is, for example, contained within the first fifth data object. There may be multiple second fifth data objects. The viewer, for example, is an analyst of the statistical information and can use a second fifth data object ID to identify the second fifth data object to which the viewer belongs. The viewer terminal VT transmits a viewing request (i.e., viewing request from the viewer) to view the statistical information to the statistical information analysis site SI0 via the communication network NW, in response to an instruction from the viewer. As a result, the viewing request from the viewer is transmitted from the statistical information analysis site SI0 to the statistical information providing server SE2. In response to the viewing request, the statistical information providing server SE2 can cause the statistical information based on the fourth data object information to be displayed on a display device of the viewer terminal VT through the statistical information analysis site SI0.

Moreover, a first fifth data object site SI1 and a second fifth data object site SI2 are connected to the communication network NW. The first fifth data object site SI1 is the website (an example of a first website) of the first fifth data object and is provided by its web server or similar resources. The URL (Uniform Resource Locator) of the first fifth data object site SI1 is allocated to it. The URL of the first fifth data object site SI1 is based on the domain of the first fifth data object. The second fifth data object site SI2 is the website (an example of a second website) of the second fifth data object and is provided by its web server or similar resources. The URL of the second fifth data object site SI2 is allocated to it. The URL of the second fifth data object site SI2 is based on the domain of the second fifth data object. The domain of the first fifth data object and the domain of the second fifth data object are different from each other. Incidentally, if there may be multiple second fifth data objects, there is the second fifth data object site SI2 for each second fifth data object (i.e., there are the multiple second fifth data object sites SI2).

Furthermore, first data object terminals UTn (n=1, 2, . . . ) used by each of a plurality of first data objects can be connected to the communication network NW. Here, the plurality of first data objects (second first data objects) includes a first data object (first data object) who is the fourth data object and a first data object who is not the fourth data object. Each of the first data object terminals UTn is, for example, a smartphone, a tablet, or a personal computer on which an OS (Operating System) and a browser are installed.

The first data object terminal UTn can access the first fifth data object site SI1 via the communication network NW by specifying the URL of the first fifth data object site SI1 in the browser. Then, the first data object terminal UTn can process the web page provided by the first fifth data object site SI1 in the browser. Such processing includes, for instance, display processing and script-based processing. This allows the first data object of the first data object terminal UTn to use a predetermined service provided by the first fifth data object through the displayed web page. Here, examples of the predetermined service include an information-providing service,, and various reservation services. The processing related to these services is carried out by the fourth data object processing server SE6.

Moreover, if the first data object of the first data object terminal UTn accessing the first fifth data object site SI1 is the fourth data object, cookie information issued (generated) by the web server of the first fifth data object upon access of the first data object terminal UTn to the first fifth data object site SI1 via the communication network NW using its browser, is stored in the browser. For example, once the first data object terminal UTn accesses the first fifth data object site SI1 and the fourth data object logs in through a login process using the fourth data object ID, the cookie information issued by the web server of the first fifth data object is stored in the browser of the first data object terminal UTn. The cookie information includes, for example, the issuance date (e.g., the date and time) of the cookie information, the domain of the first fifth data object (or the URL containing the domain), the fourth data object ID of the fourth data object identified through the login, and the like. Incidentally, such cookie information may include a simplified ID that can be associated with the fourth data object's fourth data object ID. The simplified ID is different for each browser, for example, even if they are the same fourth data object.

Moreover, the first data object terminal UTn can access the second fifth data object site SI2 via the communication network NW by specifying the URL of the second fifth data object site SI2 in the browser. Then, the first data object terminal UTn can process the web page provided by the second fifth data object site SI2 in the browser. Such processing includes, for instance, display processing and script-based processing. This allows the first data object of the first data object terminal UTn to use a predetermined service by the second fifth data object through the displayed web page. Here, examples of the predetermined service include an information-providing service, and various reservation services, similar to the predetermined service provided by the first fifth data object. The first data object who can use the predetermined service provided by the second fifth data object may become a second data object of the second fifth data object.

Moreover, it would be desirable for an information acquisition tag provided by the first fifth data object to be set on the second fifth data object site SI2. The information acquisition tag may be a script written in a programming language such as JavaScript (a registered trademark). Here, the information acquisition tag includes program code for transmitting, to the domain of the first fifth data object, third data object information indicating that the first data object has visited the second fifth data object site SI2. The third data object information is information of a third data object who has visited the second fifth data object site SI2. As a result, when the information acquisition tag included in the web page provided by the second fifth data object site SI2 is executed by the browser, the third data object information (including, for example, the URL of the second fifth data object site SI2) is transmitted to the third data object information collection server SE5 via the communication network NW. Therefore, the third data object information is collected by the third data object information collection server SE5, and is provided from the third data object information collection server SE5 to the third data object statistical information server SE4 after, for example, a predetermined data processing is performed. Accordingly, the third data object information (e.g., the number of third data object) of third data object to the second fifth data object site SI2 can be appropriately identified on the first fifth data object side through the information acquisition tag.

In this case, if the first data object of the first data object terminal UTn is the fourth data object and the cookie information including the fourth data object ID of this fourth data object is stored in the browser of the first data object terminal UTn, the first data object terminal UTn transmits the third data object information including the cookie information to the third data object information collection server SE5 in accordance with the information acquisition tag in the browser. As a result, the third data object information is collected by the third data object information collection server SE 5, and is provided from the third data object information collection server SE 5 to the third data object statistical information server SE4 after, for example, a predetermined data processing is performed. Accordingly, the first fifth data object can appropriately determine the extent to which third data objects to the second fifth data object site SI2 (in other words, the third data object to the second fifth data object) include fourth data objects of the first fifth data object.

### [1-1. Configuration and Function of Viewer Terminal VT]

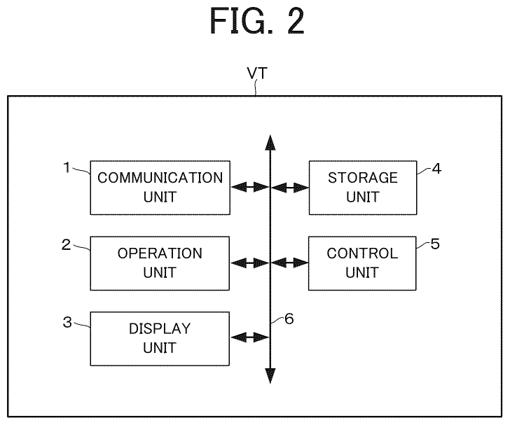

Next, a configuration and a function of the viewer terminal VT will be described with reference to FIG. 2. FIG. 2 is a diagram illustrating a schematic configuration example of the viewer terminal VT. As illustrated in FIG. 2, the viewer terminal VT includes a communication unit 1, an operation unit 2, a display unit 3, a storage unit 4, a control unit 5, and the like. These components are connected via a bus 6. For example, a personal computer can be applied to the viewer terminal VT. The communication unit 1 has a function to communicate with the statistical information analysis site SI0 by connecting to the communication network NW. The operation unit 2 has a function of receiving instructions (e.g., a selection instruction, an input instruction, a scroll-down instruction, etc.) from the viewer's finger, pen, or mouse, and outputting an instruction signal corresponding to the received instruction to the control unit 5. The display unit 3 has a function to display various screens on a display device (i.e., display device connected to the display unit 3) of the viewer terminal VT.

The storage unit 4 includes, for example, an SSD (Solid State Drive) or an HDD (Hard Disk Drive), and stores various programs (program code groups) and data. The various programs include an OS (Operating System), an application, and a browser. The control unit 5 (an example of a computer) includes at least one CPU (Central Processing Unit), a ROM (Read Only Memory), a RAM (Random Access Memory), and the like. The control unit 5 accesses the statistical information analysis site SI0 by the browser in response to the instruction from the viewer. Once the viewer logs in through the login process using the second fifth data object ID, the control unit 5 causes the display device of the display unit 3 to display a statistical information display screen.

Here, the statistical information display screen is a screen for displaying the statistical information based on the fourth data object information, but the statistical information is not yet displayed at the initial stage immediately after login. For example, once an instruction to select a button, provided on the statistical information display screen, for generating statistical information is issued, a data source selection screen is displayed as a popup on the statistical information display screen. The data source selection screen is a screen for selecting a data source for generating (creating) the statistical information.

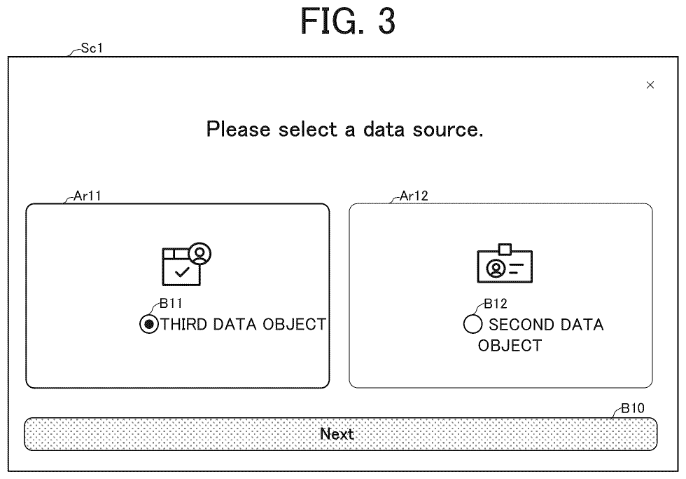

FIG. 3 is a diagram illustrating an example of the data source selection screen. As illustrated in FIG. 3, the data source selection screen Sc1 is provided with Third Data Object Information Selection Area Ar11, Second data object Information Selection Area Ar12, Next Button B10, and the like. The Third Data Object Information Selection Area Ar11 is provided with Radio Button B11 for selecting third data object information of the third data object to the second fifth data object site SI2, as a data source for generating the statistical information. The Second data object Information Selection Area Ar12 is provided with Radio Button B12 for selecting second data object information of the second data object of the second fifth data object, as a data source for generating the statistical information.

For example, once an instruction to select the Next Button B10 is issued while the Radio Button B11 in the Third data object Information Selection Area Ar11 is selected, the control unit 5 transmits a viewing request to view the statistical information to the statistical information analysis site SI0 via the communication unit 1. Here, the viewing request indicates the selection of third data object information as the data source. The third data object information is information transmitted (collected) to the third data object information collection server SE5 by the information acquisition tag set on the second fifth data object site SI2, as described above.

On the other hand, once an instruction to select the Next Button B10 is issued while the Radio Button B12 in the Second data object Information Selection Area Ar12 is selected, a second data object information upload screen (not shown) is displayed as a popup on the statistical information display screen. The second data object information upload screen is a screen for uploading a second data object information list (e.g., a CSV file). The second data object information list is, for example, a list of the second data object information of the second fifth data object. The second data object information list is acquired from a database of the second fifth data object by the viewer terminal VT and can be stored in the storage unit 4. Here, the second data object information is, for example, information registered in the database of the second fifth data object when the first data object, as the customer, uses the predetermined service by the second fifth data object. The second data object information includes an email address (an example of second information) of the first data object. As another example, the second data object information may include the phone number of the first data object, or the name of the first data object.

In the second data object information upload screen, once an instruction to select a submit button (not shown) is issued after the second data object information list is designated (specified) from the storage unit 4, the control unit 5 transmits a viewing request to view the statistical information along with the second data object information list to the statistical information analysis site SI0 via the communication unit 1. Here, the viewing request indicates the selection of second data object information as the data source. As a result, the viewing request is transmitted, along with the second data object information list, from the statistical information analysis site SI0 to the third data object information collection server SE5. Incidentally, the control unit 5 may transmit, along with the second data object information list, the viewing request indicating the selection of third data object information and second data object information as data sources to the statistical information analysis site SI0 via the communication unit 1.

Then, once display control data for displaying the statistical information through the statistical information analysis site SI0 is received from the statistical information providing server SE2 in response to the transmitted viewing request as described above, the control unit 5 displays, based on the received display control data, the statistical information based on the fourth data object information on the statistical information display screen. Alternatively, the control unit 5 limits (or restricts), based on the received display control data, the display of the statistical information based on the fourth data object information.

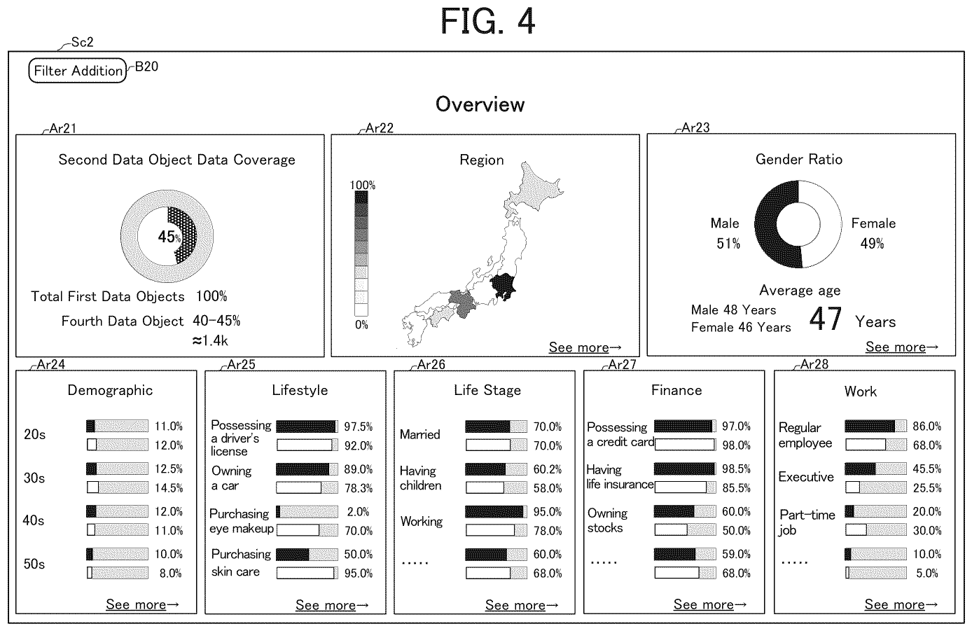

FIG. 4 is a diagram illustrating an example of a statistical information display screen showing the statistical information based on the fourth data object information. As illustrated in FIG. 4, the statistical information display screen Sc2 is provided with Second data object Data Coverage Area Ar21, Region Area Ar22, Gender Ratio (Male/Female Ratio) Area Ar23, Demographic Area Ar24, Lifestyle Area Ar25, Life Stage Area Ar26, Finance Area Ar27, and Work Area Ar28.

Here, the statistical information displayed in the Second data object Data Coverage Area Ar21 is presented as both numerical values (e.g., 40-45%) and a pie chart, representing the ratio (in other words, percentage) of the number of pieces of the fourth data object information to the number of pieces of the third data object information (or the number of pieces of the second data object information). In this example, the number of pieces of the third data object information (or the number of pieces of the second data object information) is expressed as “Total First data objects 100%”. The ratio is calculated by dividing the number of pieces of the fourth data object information by the number of pieces of the third data object information (or the number of pieces of the second data object information). Incidentally, the number of pieces of the third data object information refers to the number of third data objects (referred to as “third data object count”), while the number of pieces of the second data object information refers to the number of customers (referred to as “second data object count”). The number of pieces of the fourth data object information refers to the number of fourth data objects (referred to as “total fourth data object count”) included in the third data objects or customers.

Incidentally, in the Second data object Data Coverage Area Ar21, the number of individuals (i.e., fourth data objects) may be displayed as a numerical value instead of the ratio, or alongside it. In this case, for instance, the statistical information displayed in the Second data object Data Coverage Area Ar21 includes the third data object count or second data object count, as well as the total fourth data object count, presented as numerical values. In this case, the numerical value representing the total fourth data object count may be displayed as an approximate actual number of objects(e.g., Approximately 1.4k), as shown in FIG. 4, within the Second data object Data Coverage Area Ar21.

The statistical information displayed in the Region Area Ar22 is presented as the ratio of fourth data objects'residential areas (e.g., prefectures), with color intensity representing the distribution. For example, higher ratios are represented with darker colors. The ratio of fourth data objects'residential areas is calculated, for example, by dividing the number of fourth data objects (referred to as “fourth data object count”) in each residential area by the total fourth data object count. The fourth data object count in each residential area refers to the number of fourth data objects belonging to groups classified based on their residential area, such as the group of fourth data objects residing in Hokkaido, the group of fourth data objects residing in Tohoku, and the group of fourth data objects residing in Kanto, etc. Here, once an instruction to select “See more” displayed in the Region Area Ar22 is issued, the screen transitions to a new screen (not shown) that displays the ratio of fourth data objects'residential areas numerically.

The statistical information displayed in the Gender Ratio Area Ar23 is presented as both numerical values and a pie chart, representing the ratio of genders associated with fourth data objects.

The statistical information displayed in the Demographic Area Ar24 is presented as both numerical values and bar charts, representing the ratio of genders and generations associated with fourth data objects. Generation refers to an age range associated with a fourth data object falls into.

The statistical information displayed in the Lifestyle Area Ar25 is presented as both numerical values and bar charts, representing the ratio of lifestyles and genders associated with fourth data objects. The fourth data object count by lifestyle and gender refers to the number of lifestyle and gender-specific groups associated with fourth data objects such as the group of males who possess a driver's license, the group of females who possess a driver's license, the group of males who purchased eye makeup, and the group of females who purchased eye makeup, etc.

The statistical information displayed in the Life Stage Area Ar26 is presented as both numerical values and bar charts, representing a life stage and gender ratio associated with fourth data objects. The fourth data object count by life stage and gender refers to a marital and gender status associated with fourth data objects.

The statistical information displayed in the Finance Area Ar27 is presented as both numerical values and bar charts, representing a financial and gender ratio associated with fourth data objects.

The statistical information displayed in the Work Area Ar28 is presented as both numerical values and bar charts, representing an occupation and gender ratio associated with fourth data objects by occupation (in other words, job type or employment status) and gender.

Incidentally, in the Regional Area Ar22, the Gender Ratio Area Ar23, the Demographic Area Ar24, the Lifestyle Area Ar25, the Life Stage Area Ar26, the Finance Area Ar27, and the Work Area Ar28, the number of individuals (i.e., fourth data objects) may be displayed as a numerical value instead of the ratio or alongside it. In statistical information display screen Sc2 illustrated in FIG. 4, once a scroll-down instruction is issued, the scroll-down of the screen is performed, and details of the statistical information displayed in the Demographic Area Ar24, the Lifestyle Area Ar25, the Life Stage Area Ar26, the Finance Area Ar27, and the Work Area Ar28 can be displayed.

The aforementioned residential area, gender, generation, lifestyle, life stage, finance (financial stage), and occupation are examples of predefined attribute items (also referred to as categories) and are used as a grouping condition for classifying the fourth data objects into one of a plurality of groups (in other words, for grouping the fourth data objects). That is, the grouping condition is a criterion used to group the fourth data objects. Fourth data object's attributes (attribute values) are associated with each attribute item. The statistical information displayed in the Regional Area Ar22, the Gender Ratio Area Ar23, the Demographic Area Ar24, the Lifestyle Area Ar25, the Life Stage Area Ar26, the Finance Area Ar27, and Work Area Ar28 can be described as group-specific statistical information, where groups are classified based on fourth data object attributes corresponding to each attribute item. The number of fourth data objects belonging to a group is referred to as the “group fourth data object count.”

Incidentally, each group is assigned a group ID to identify the group. Moreover, the grouping may be performed based on a single attribute item (e.g., residential area) as the grouping condition, to form the group of fourth data objects, such as the group of fourth data objects residing in Hokkaido. Moreover, the grouping may be performed based on a combination of two attribute items (e.g., generation and gender) as the grouping condition, to form the group of fourth data objects, such as the group of male fourth data objects in their 40s. Furthermore, although not shown, the grouping may be performed based on a combination of three or more attribute items (a combination of multiple types of attribute items) as the grouping condition.

Once an instruction to select Filter Addition Button B20 provided on the statistical information display screen Sc2 is issued, a grouping condition setting screen (not shown) is displayed as a popup on the statistical information display screen Sc2. The grouping condition setting screen is a screen for setting the grouping condition for grouping the fourth data objects. In the grouping condition setting screen, the viewer can designate one or more attribute items as the grouping condition, for example, from a list of attribute items.

Here, a single attribute item may be designated multiple times, a combination of multiple types of attribute items may be designated multiple times, alternatively, a single attribute item and a combination of multiple types of attribute items may be designated together. Attribute item designation information (referred to as “first attribute item designation information”) which indicates the attribute items designated by the viewer, is transmitted to the statistical information analysis site SI0 via the communication unit 1. Then, the first attribute item designation information is transmitted from the statistical information analysis site SI0 to the statistical information providing server SE2.

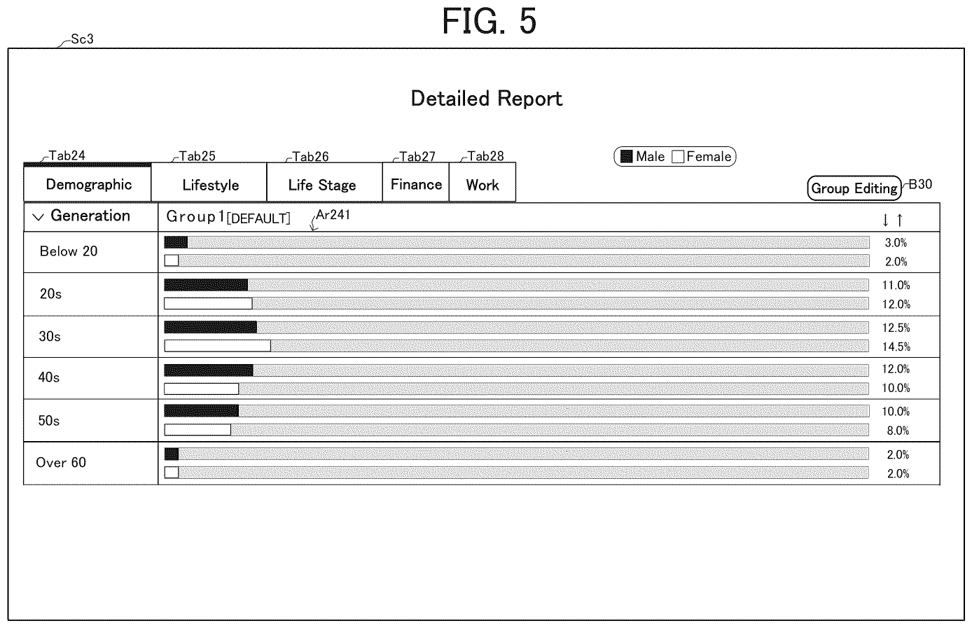

FIG. 5 is a diagram illustrating an example of a statistical information display screen showing details of the statistical information based on the fourth data object information. As illustrated in FIG. 5, the statistical information display screen Sc3 is provided with Demographic Tab24, Lifestyle Tab25, Life Stage Tab26, Finance Tab27, and Work Tab28. In the example of FIG. 5, the Demographic Tab24 is currently selected among the Tab24-Tab28. Therefore, in the example of FIG. 5, Detailed Demographic Area Ar241 is displayed at the bottom of the Tab24-Tab28 on the statistical information display screen Sc3.

In the Detailed Demographic Area Ar241, detailed statistical information based on the fourth data objects'generation and gender is displayed, including information which is not fully covered in the Demographic Area Ar24. Incidentally, in statistical information display screen Sc3 illustrated in FIG. 5, for example, once an instruction to select the Life Stage Tab26 is issued, Life Stage Detail Area (not shown) is displayed at the bottom of the Tab24-Tab28 on the statistical information display screen Sc3.

Moreover, in the example of FIG. 5, the groups shown in the Detailed Demographic Area Ar241 are collectively expressed as Group1. The group named Group1 is an example of an “aggregate group”. Therefore, the Detailed Demographic Area Ar241 shown in FIG. 5 is referred to as the Detailed Demographic Area Ar241 for Group1. The multiple groups shown in the Detailed Demographic Area Ar241 for Group1 can each be regrouped based on the fourth data objects'attributes with respect to specific attribute items. That is, regrouping can be performed.

Regrouping means, with respect to one or more specific attribute items, generating a regroup (i.e., a new group) by extracting fourth data objects from the group (i.e., narrowing down the fourth data objects) based on the attributes of fourth data objects belonging to the group shown in the Detailed Demographic Area Ar241 for Group1. For example, regrouping of the group fourth data objects having a first and second attribute generates a new group of fourth data objects who also have the first and second attribute. Such regrouping is a type of the grouping.

The specific attribute items include at least one of the following: the terminal type of first data object terminal UTn (i.e., the type of first data object terminal UTn used by the fourth data object), the name of its operating system (OS name), the name of its browser (browser name), the name of a purchased product (purchased product name) which refers to a product bought by the fourth data object, the name of the store that sold the product (purchase store name), the total purchase amount, and the number of posted reviews on purchased products. For example, once an instruction to select Group Editing Button B30 provided on the statistical information display screen Sc3 is issued, a group editing screen is displayed as a popup on the statistical information display screen Sc3. The group editing screen is a screen for setting the grouping condition for editing (including regrouping) the group shown in the Detailed Demographic Area Ar241 for Group1.

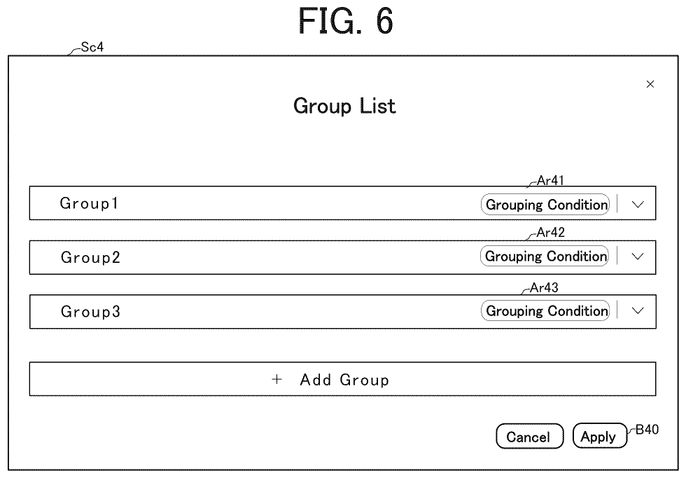

FIG. 6 is a diagram illustrating an example of the group editing screen. As illustrated in FIG. 6, the group editing screen Sc4 is provided with Grouping Condition Setting Areas Ar41 to Ar43. The Grouping Condition Setting Area Ar41 is an area for setting the grouping condition for regrouping the groups shown in the Detailed Demographic Area Ar241 for Group1 as shown in FIG. 5. For example, in the Grouping Condition Setting Area Ar41, the viewer can designate one or more specific attribute items (e.g., a smartphone as the terminal type) as the grouping condition, for example, from a list of attribute items. Moreover, in the Grouping Condition Setting Area Ar41, the viewer can also designate another specific attribute item (e.g., a total purchase amount of $700) as the grouping condition. Incidentally, as the specific attribute item, an attribute item other than the attribute item (e.g., generation) corresponding to the selected Tab may be designated in the statistical information display screen Sc3.

Then, once an instruction to select Apply Button B40 provided on the group editing screen Sc4 is issued, attribute item designation information (referred to as “second attribute item designation information”) is transmitted to the statistical information analysis site SI0 via the communication unit 1. The second attribute item designation information indicates one or more specific attribute items (which may be a combination of multiple attribute items) designated by the viewer and the group ID of each group included in the aggregate group subject to the designation of at least one specific attribute item. The second attribute item designation information is then transmitted from the statistical information analysis site SI0 to the statistical information providing server SE2. As a result, the statistical information on each regrouped group, which has been reorganized based on the attributes of fourth data objects belonging to each group within the aggregate group (Group1) with respect to at least one specific attribute item, is updated and displayed on the statistical information display screen Sc3. Incidentally, the Grouping Condition Setting Area Ar42 is an area for setting the grouping condition for adding or editing an aggregate group (Group2) independent of the aggregate group (Group1). For example, in the Grouping Condition Setting Area Ar42, the viewer can add a new aggregate group (Group2) by designating one or more specific attribute items as the grouping condition. Similarly, the Grouping Condition Setting Area Ar43 is an area for setting the grouping condition for adding or editing an aggregate group (Group3) independent of the aggregate groups (Group1 and Group2). For example, in the Grouping Condition Setting Area Ar43, the viewer can add a new aggregate group (Group3) by designating one or more specific attribute items as the grouping condition.

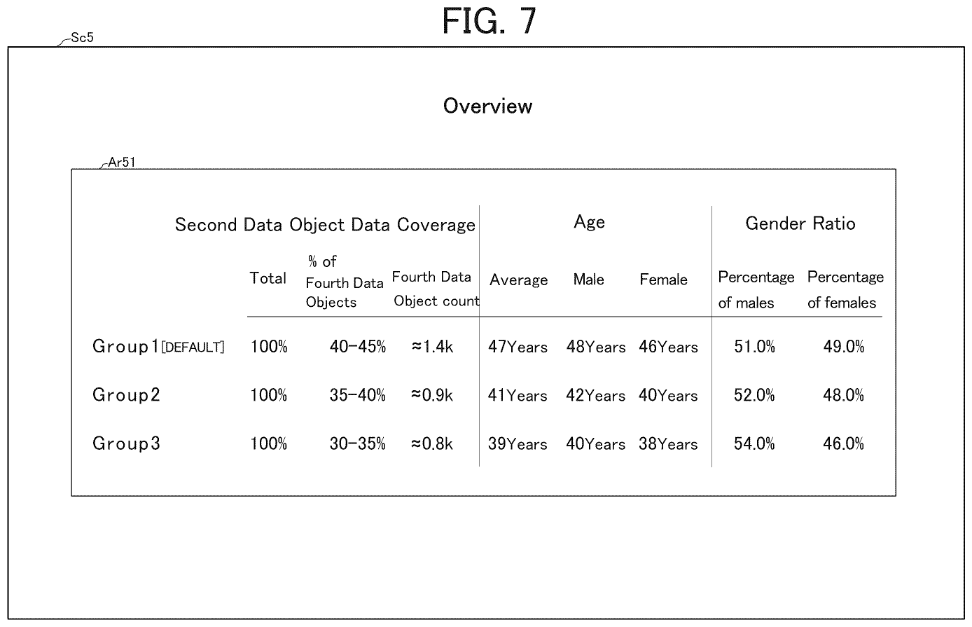

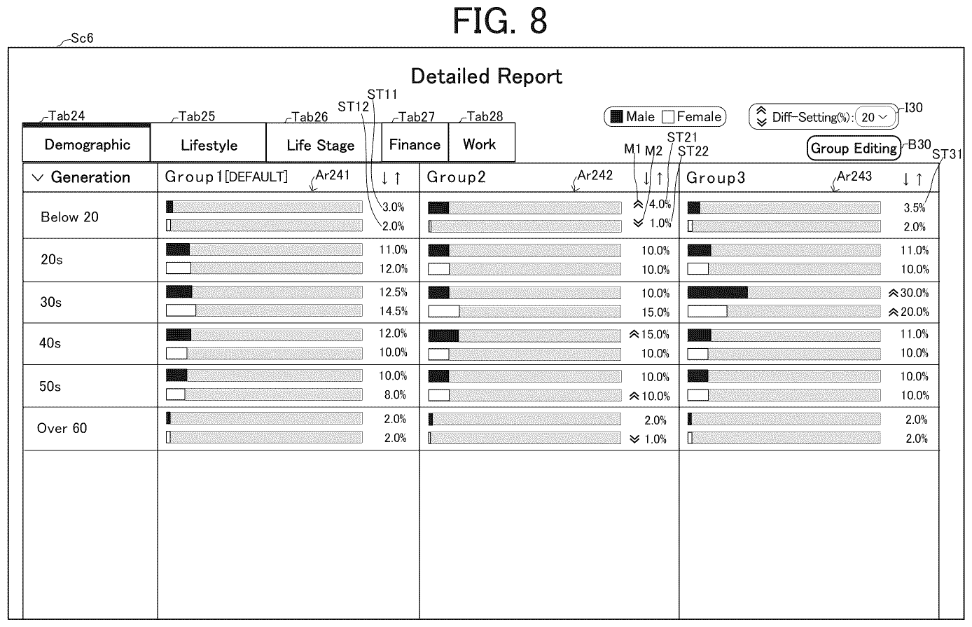

FIGS. 7 and 8 are diagrams illustrating statistical information display screens, showing an example where the statistical information on each group within each aggregate group (Group2 and Group3) has been additionally displayed. As illustrated in FIG. 7, the statistical information display screen Sc5 is provided with Area Ar51 as an overview display area for displaying the statistical information based on the fourth data object information. The Area Ar51 displays the second data object data coverage, age, and gender ratio of each of Group1 to Group3, making it possible to compare these aspects between Group1, Group2, and Group3. That is, the Area Ar51 allows for a comparative display of the second data object data coverage, age, and gender ratio across Group1 to Group3. On the other hand, as illustrated in FIG. 8, on the statistical information display screen Sc6, in addition to the Detailed Demographic Area Ar241 for Group1, Detailed Demographic Areas Ar242 and Ar243 for Group2 and Group3, respectively, are additionally displayed. Here, the Detailed Demographic Area Ar242 for Group2 displays the statistical information on each group within the aggregate group (Group2), which has been added based on the grouping condition designated in the Grouping Condition Setting Area Ar42 illustrated in FIG. 6. For example, these groups may include gender specific, generation specific, or smart phone usage groups associated with fourth data objects. On the other hand, the Detailed Demographic Area Ar243 for Group3 displays the statistical information on each group within the aggregate group (Group3), which has been added based the grouping condition designated in the Grouping Condition Setting Area Ar43 illustrated in FIG. 6. For example, these groups may include purchase amount specific, gender-and generation-specific groups associated with fourth data objects. Data objects may be grouped based on being associated with a purchase amount above a predetermined threshold. For example, $700.

Incidentally, the statistical information on each group within the aggregate group (Group2) is presented as both numerical values and bar charts, representing the ratio of fourth data objects in each group relative to the total number of fourth data objects (an example of the group fourth data object count) in the aggregate group (Group2), which is set at 100%. Moreover, the statistical information on each group within the aggregate group (Group3) is presented as both numerical values and bar charts, representing the ratio of fourth data objects in each group relative to the total number of fourth data objects in the aggregate group (Group3), which is set at 100%.

Moreover, in the Detailed Demographic Area Ar242 for Group2, for example, the statistical information ST21 on the group within Group2 (in this example, the group having the same gender and generation) corresponding to the group of male fourth data objects under 20 years old within Group1 is displayed with an associated Up Arrow Mark M1. Moreover, in the Detailed Demographic Area Ar242 for Group2, for example, the statistical information ST22 on the group corresponding to the group of females under 20 years old associated with fourth data objects is displayed with an associated Down Arrow Mark M2. In this way, the group within Group1 and the corresponding group within Group2 are referred to as corresponding groups (i.e., groups that have a corresponding relationship). Similarly, the group within Group1 and the corresponding group within Group3 are referred to as corresponding groups. Incidentally, the Up Arrow Mark M1 and the Down Arrow Mark M2 may be configured to be distinguished by different display colors.

For example, the Up Arrow Mark M1 is a mark used to emphasize the statistical information ST21 on the group within Group2. This emphasis is based on the difference (i.e., the absolute value of the difference between the corresponding groups) between the numerical value represented by the statistical information ST11 on the group within Group1 and that represented by the statistical information ST21 on the corresponding group within Group2. The Up Arrow Mark M1 may be displayed when the following requirements (i) and (ii) are met:

(i) The numerical value (e.g., 4.0%=0.04) represented by the statistical information ST21 on the group within Group2 is greater than the numerical value (e.g., 3.0%=0.03) represented by the statistical information ST11 on the corresponding group within Group1.
(ii) The difference (e.g., 1.0%=0.01) between the corresponding groups (i.e., the group within Group2 and the corresponding group within Group1) is greater than the value (e.g., 0.6%=0.006=0.03*0.2) obtained by multiplying the numerical value represented by the statistical information ST11 on the group within Group1 by a predetermined difference-setting value (e.g., 20%=0.2).
Incidentally, among the corresponding groups, the numerical value (e.g., 3.5%=0.035) represented by the statistical information ST31 on the group within Group3 is greater than the numerical value represented by the statistical information ST11 on the corresponding group within Group1. However, since the difference (e.g., 0.5%=0.005) between the corresponding groups does not exceed the value (e.g., 0.6%=0.006=0.03*0.2) obtained by multiplying the numerical value represented by the statistical information ST11 on the group within Group1 by the difference-setting value (e.g., 20%=0.2), the Up Arrow Mark M1 is not displayed in association with the statistical information ST31.

On the other hand, the Down Arrow Mark M2 is a mark used to emphasize the statistical information ST22 on the group within Group2. This emphasis is based on the difference (i.e., the absolute value of the difference between the corresponding groups) between the numerical value represented by the statistical information ST12 on the group within Group1 and that represented by the statistical information ST22 on the corresponding group within Group2. The Down Arrow Mark M2 may be displayed when the following requirements (iii) and (iv) are met:

(iii) The numerical value (e.g., 1.0%=0.01) represented by the statistical information ST22 on the group within Group2 is smaller than the numerical value (e.g., 2.0%=0.02) represented by the statistical information ST12 on the corresponding group within Group1.
(iv) The difference (e.g., 1.0%=0.01) between the corresponding groups is greater than the value (e.g., 0.4%=0.004=0.02*0.2) obtained by multiplying the numerical value represented by the statistical information ST12 on the group within Group1 by a predetermined difference-setting value (e.g., 20%=0.2).
The viewer can designate the difference-setting value in Diff-Setting Field I30 provided on the statistical information display screen Sc6, such as by selecting it from a list of options. Incidentally, difference-setting value designation information indicating the difference-setting value designated by the viewer is transmitted to the statistical information analysis site SI0 via the communication unit 1. The difference-setting value designation information is then transmitted from the statistical information analysis site SI0 to the statistical information providing server SE2.

The display of at least a portion of the statistical information displayed on the statistical information display screen Sc2, Sc3, Sc5, and Sc6 described above is limited in response to the third data object count or second data object count being equal to or less than a first threshold value (e.g., 5 to 10), or the fourth data object count being equal to or less than a second threshold value (e.g., 3 to 8). Here, the fourth data object count compared with the second threshold value is any one of the total fourth data object count or group fourth data object count. The limitation of the display of the statistical information is performed based on a display control data from the statistical information providing server SE2. The limiting the display of the statistical information includes, for example, either concealing the statistical information or rendering the statistical information ambiguous (i.e., displaying it in an ambiguous manner), or both.

Here, the concealing the statistical information includes the following methods: (a) simply not displaying the statistical information, (b) overlaying a mask image (e.g., a black or gray image) on the display area of the statistical information, or (c) displaying the statistical information in the same color as the background color of the statistical information. The method (c) refers to changing the display color of the statistical information (e.g., black) to match the background color (e.g., white), effectively making the statistical information indistinguishable from the background. Moreover, when concealing statistical information, it may be configured to display a message indicating that the statistical information cannot be displayed. On the other hand, the rendering the statistical information ambiguous includes, for example, displaying a numerical range that includes a numerical value represented by the statistical information while refraining from directly displaying the numerical value. Incidentally, if the data source selected by the viewer is the third data object information, the display of the statistical information may not be limited. On the other hand, if the data source selected by the viewer is the second data object information, it may be configured to limit the display of the statistical information.

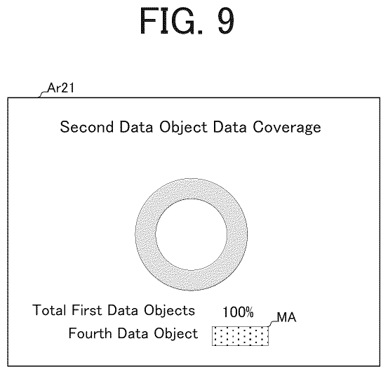

FIG. 9 is a diagram illustrating an example of the statistical information being concealed in the Second data object Data Coverage Area Ar21. In the example of FIG. 9, a mask image MA is overlaid on the display area of numerical values representing the statistical information, and the pie chart representing the statistical information is concealed. Here, the mask image MA is overlaid on the display area of the numerical values representing the statistical information while a pie chart representing the statistical information may be displayed simultaneously. In this case, the display of the portion of the statistical information is limited. Incidentally, instead of the mask image MA being overlaid on the display area of the numerical values representing the statistical information, the numerical range that includes the numerical values representing the statistical information may be displayed (i.e., rendering the statistical information ambiguous). In this case, for example, it is preferable to display, such as “10 objects or fewer”, the numerical range including the numerical value (e.g., 3 objects) representing the statistical information. Alternatively, in this case, the numerical range including an approximate actual number of data objects (e.g., Approximately 1.4 k) may be displayed.

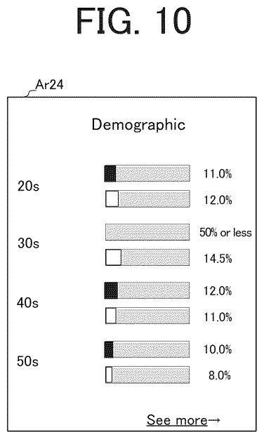

FIG. 10 is a diagram illustrating an example in which the statistical information on the group with the total fourth data object count or group fourth data object count being equal to or less than the second threshold value is ambiguously displayed or concealed among the plurality of groups shown in the Demographic Area Ar24. In the example of FIG. 10, the numerical range (e.g., 50% or less) that includes the numerical value representing the statistical information on the group associated with men in their 30s is displayed ambiguously, while the bar chart representing the statistical information is concealed. This ambiguous display allows the viewer to gain some understanding of the statistical information based on the fourth data object information, while simultaneously more appropriately ensuring the protection of information on the privacy of the fourth data objects.

[1-2. Configuration and Function of Fourth data object Information Management Server SE1]

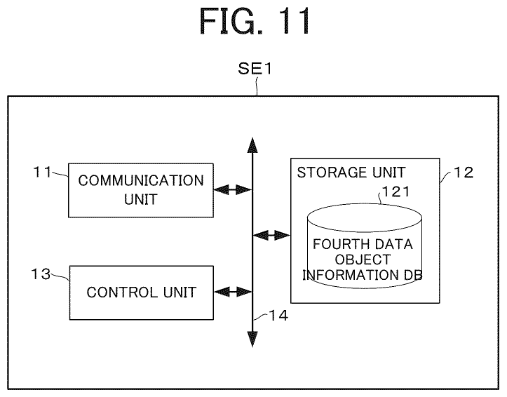

Next, a configuration and a function of the fourth data object information management server SE1 will be described with reference to FIG. 11. FIG. 11 is a diagram illustrating a schematic configuration example of the fourth data object information management server SE1. As illustrated in FIG. 11, the fourth data object information management server SE1 includes a communication unit 11, a storage unit 12, a control unit 13, and the like. These components are connected via a bus 14. The communication unit 11 has a function to communicate with the fourth data object statistical information server SE3, for example, via the dedicated line. The storage unit 12 includes, for example, an SSD or an HDD, and stores various programs (program code groups) and data. A fourth data object information database (DB)121 is constructed in the storage unit 12.

The fourth data object information database 121 is a database for managing the fourth data object information of fourth data objects registered (i.e., account issued) through the fourth data object registration procedure by the first fifth data object. In the fourth data object information database 121, the fourth data object information is individually stored for each fourth data object. The fourth data object information is associated with the fourth data object ID of the fourth data object and the email address (or telephone number) of the fourth data object. Incidentally, the simplified ID may be associated with the fourth data object ID. The fourth data object information is provided to the statistical information providing server SE2 through the fourth data object statistical information server SE3 and is used to generate the statistical information. The fourth data object information includes the fourth data object's name, address, password, survey response information, terminal information, transaction information, attribute information and the like.

Here, the password is account information for logging in to, for example, the first fifth data object site SI1 along with the fourth data object ID. The survey response information indicates responses to surveys conducted for the fourth data object. The survey response information is collected, for example, during the fourth data object registration procedure by the first fifth data object or during a subsequent update procedure, and stored in the fourth data object information database 121. The terminal information indicates the terminal type, OS name, browser name, and the like. For example, the terminal information is acquired when the fourth data object's first data object terminal UTn accesses the first fifth data object site SI1 and stored in the fourth data object information database 121.

The transaction information indicates the history (e.g., purchase history or reservation history) of the fourth data object's transaction in the business (e.g., business related to commercial transaction) of the first fifth data object. The transaction information is acquired at predetermined timings, such as when the predetermined service provided through the first fifth data object site SI1 is used by the fourth data object, from the fourth data object processing server SE6, etc., and stored in the fourth data object information database 121. The attribute information indicates the fourth data object's attributes (attribute values) for each of the plurality of attribute items. That is, the attribute information indicates the attributes (attribute values) associated with each attribute item. The attribute information is acquired, for example, during the fourth data object registration procedure by the first fifth data object or during a subsequent update procedure, and stored in the fourth data object information database 121. For example, the attribute item “Residential Area” is associated with the attribute “Hokkaido” (based on the fourth data object's address), the attribute item “Gender” is associated with the attribute “Male”, and the attribute item “Generation”is associated with the attribute “40s”.

Moreover, depending on the attribute item, the attribute may be extracted by analyzing previously acquired data, such as the survey response information, the terminal information, or the transaction information. For example, the attribute item “Lifestyle” may be associated with the attributes such as “Possessing a driver's license”, “Owning a pet (cat or dog)”, “Owning a car”, “Living in a single-family home”, “Playing golf”, “Swimming”, “Purchasing foundation”, “Purchasing lip products”, and “Purchasing eye makeup”. Thus, a single attribute item can be associated with the plurality of attributes.

Moreover, for example, the attribute item “Life Stage” may be associated with the attributes such as “Married”, “Having children”, and “Highest education level is university”. Moreover, for example, the attribute item “Finance” may be associated with the attributes such as “Having auto insurance”, “Annual income of $30,000”, “Possessing a credit card”, and “Owning stocks”. Furthermore, for example, the attribute item “Work” may be associated with the attribute “Executive”. Incidentally, the statistical information based on attributes extracted through the analysis of the transaction information can be referred to as “the statistical information based on the transaction information”.

Moreover, the same applies to the specific attribute items described above. For example, the attribute item “Terminal type” is associated with the attribute “Smartphone”, the attribute item “OS name” is associated with the attribute “OS24”, and the attribute item “Browser name” is associated with the attribute “BROWSER XYZ”. Moreover, for example, the attribute item “Purchased product name” is associated with the attributes “Foundation”, “Lip products”, and “Eye makeup”. Furthermore, for example, the attribute item “Total purchase amount” is associated with the attribute “$620”, and the attribute item “Number of posted reviews” is associated with the attribute “90”. Incidentally, depending on a certain attribute item, the attribute can be inferred (e.g., inferred using a machine learning model) based on at least any one of the following: attribute information related to an attribute item other than the certain attribute item, the survey response information, and the transaction information.

The control unit 13 includes at least one CPU, a ROM, a RAM, and the like. The control unit 13 executes storage processing, updating processing, and providing processing of the fourth data object information in the fourth data object information database 121 as described above. Here, in the storage processing and updating processing, the control unit 13 extracts the attributes by analyzing the survey response information and/or the transaction information, etc. as appropriate. Moreover, the control unit 13 may infer the attribute based on at least any one piece of the attribute information, the survey response information, and the transaction information. Moreover, in the providing processing, the control unit 13 acquires the fourth data object information from the fourth data object information database 121, for example, in response to a request from the fourth data object statistical information server SE3, and transmits the acquired fourth data object information to the fourth data object statistical information server SE3 via the communication unit 11 and the dedicated line. Such fourth data object information is stored in the database of the fourth data object statistical information server SE3. Incidentally, the control unit 13 may be configured to acquire the fourth data object information from the fourth data object information database 121 in response to a request from the statistical information providing server SE2, and transmit the acquired fourth data object information to the statistical information providing server SE2 via the communication unit 11 and the dedicated line.

[1-3. Configuration and Function of the statistical information providing server SE2]

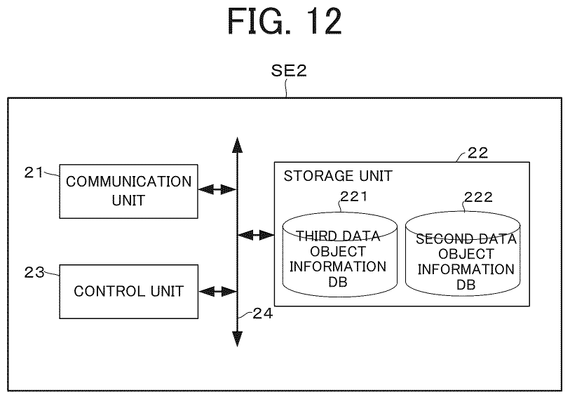

Next, a configuration and a function of the statistical information providing server SE2 will be described with reference to FIG. 12. FIG. 12 is a diagram illustrating a schematic configuration example of the statistical information providing server SE2. As illustrated in FIG. 12, the statistical information providing server SE2 includes a communication unit 21, a storage unit 22, a control unit 23, and the like. These components are connected via a bus 24. The communication unit 21 has a function to communicate with the fourth data object statistical information server SE3, the third data object statistical information server SE4, and the statistical information analysis site SI0, for example, via the dedicated line. Thus, the statistical information providing server SE2 can utilize the fourth data object information database 121 via the fourth data object statistical information server SE3. Incidentally, the statistical information providing server SE2 may be configured to directly utilize the fourth data object information database 121.

The storage unit 22 includes, for example, an SSD or an HDD, and stores various programs (program code groups) and data. Moreover, The storage unit 22 stores data that constitutes the statistical information display screen and other elements to be displayed on the viewer terminal VT. The data constituting the statistical information display screen and other elements may include structured documents data, such as HTML (Hyper Text Markup Language) or XHTML documents data, that constitutes the web page. Furthermore, a third data object information database (DB) 221 and a second data object information database (DB) 222 are constructed in the storage unit 22.

The third data object information database 221 is a database for managing the third data object information of the third data object who have visited the second fifth data object site SI2. In the third data object information database 221, the third data object information is individually stored for each second fifth data object. That is, each third data object information is stored in association with each corresponding second fifth data object ID. Incidentally, the third data object information is transmitted from the first data object terminal UTn when the information acquisition tag set on the second fifth data object site SI2 is executed by the browser of the first data object terminal UTn. Then, the third data object information is provided by the third data object statistical information server SE4 via the third data object information collection server SE5. Each of the multiple pieces of the third data object information is associated with a third data object ID, which is used to identify the corresponding third data object, and is stored in the third data object information database 221.

Moreover, the multiple pieces of the third data object information (i.e., the multiple pieces of the third data object information associated with one second fifth data object ID) stored in the third data object information database 221 include, for example, the third data object information including the cookie information and the third data object information not including the cookie information. For example, the third data object information including the cookie information can be inferred to belong to the fourth data objects, whereas the third data object information not including the cookie information can be inferred to belong to non-fourth data objects. The cookie information includes the fourth data object ID or the simplified ID, as described above. Incidentally, the third data object information transmitted from the same first data object terminal UTn (i.e., the same browser) is consolidated into a single piece of third data object information (i.e., the third data object information of one first data object).

The second data object information database 222 is a database for managing the second data object information of the second data object of the second fifth data object. In the second data object information database 222, the second data object information included in the second data object information list uploaded from the viewer terminal VT is individually stored for each the second fifth data object. That is, each second data object information is stored in association with each corresponding second fifth data object ID. The multiple pieces of the second data object information (i.e., the multiple pieces of the second data object information associated with one second fifth data object ID) stored in the second data object information database 222 include the second data object information including the fourth data object's email address and second data object information not including the fourth data object's email address.

The control unit 23 (an example of a computer) includes at least one CPU, a ROM, an RAM, and the like, and performs various processes according to the programs (program code) stored in the ROM, the storage unit 22, or the non-transitory computer readable memory. The CPU (an example of processor) is configured to access the program code stored in the ROM, the storage unit 22, or the non-transitory computer readable memory and operate as instructed by the program code. The program code includes: information acquisition code configured to cause the CPU to acquire second information of one or more second first data objects who can use a predetermined service, the one or more second first data objects including one or more first data objects, in response to the viewing request from the viewer to view the statistical information; fourth data object information acquisition code configured to cause the CPU to acquire the fourth data object information of the one or more first data objects included in the one or more second first data objects, based on the first information associated with the fourth data object information stored in the database and the acquired second information; and display control code configured to cause the CPU to execute a display limitation processing to limit, on the display device, display of at least a portion of the statistical information based on the acquired fourth data object information, in response to the number of pieces of the acquired second information being equal to or less than the first threshold value, or the number of pieces of the acquired fourth data object information being equal to or less than the second threshold value. Moreover, the program code may include: grouping code configured to cause the CPU to classify a plurality of the first data objects into one of a plurality of groups, based on at least one attribute of each of the plurality of first data objects of which the acquired fourth data object information has been; and statistical information generating code configured to the CPU to generate the statistical information on each of the plurality of groups. Moreover, the program code may include designation receiving code configured to the CPU to receive a designation of one or more attribute items among the plurality of attribute items from the viewer. In this case, grouping code is configured to cause the CPU to divide the plurality of first data objects into one of the plurality of groups, based on the attribute, with respect to the attribute item designated by the viewer, of each of the plurality of first data objects whose fourth data object information has been acquired. Incidentally, the processor may be implemented using circuitry or processing circuitry which includes general purpose processors, special purpose processors, integrated circuits, ASICs, conventional circuitry and/or combinations thereof which are configured or programmed to perform the disclosed functionality. The processor may be hardware (or a combination of hardware and software) that carry out or are programmed to perform the recited functionality.

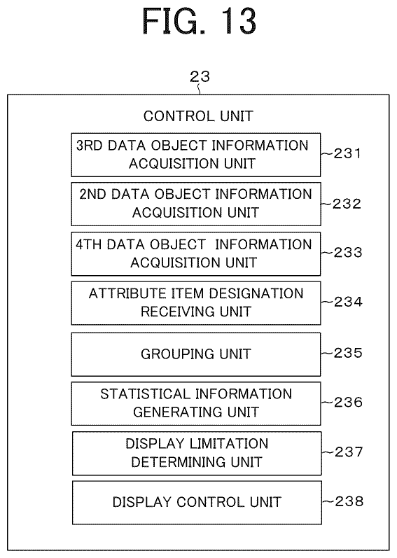

FIG. 13 is a diagram illustrating an example of functional blocks in the control unit 23. The control unit 23 functions a third data object information acquisition unit 231, a second data object information acquisition unit 232, a fourth data object information acquisition unit 233, an attribute item designation receiving unit 234, a grouping unit 235, a statistical information generating unit 236, a display limitation determining unit 237, a display control unit 238, and the like as illustrated in FIG. 13, in accordance with the program (the program code) stored in the ROM, the storage unit 22, or the non-transitory computer readable memory.

The third data object information acquisition unit 231 acquires one or more pieces of the third data object information associated with the second fifth data object ID from the third data object information database 221 in response to the viewing request, indicating the selection of third data object information as the data source, from the viewer terminal VT of the viewer logged in using the second fifth data object ID. That is, the third data object information acquisition unit 231 retrieves one or more pieces of the third data object information associated with the second fifth data object ID from the third data object information database 221.

The second data object information acquisition unit 232 acquires one or more pieces of the second data object information from the second data object information list in response to the viewing request, indicating the selection of second data object information as the data source, from the viewer terminal VT of the viewer logged in using the second fifth data object ID. The second data object information thus acquired is associated with the second fifth data object ID and stored in the second data object information database 222. Incidentally, when the viewing request along with the second data object information list are received by the communication unit 21 through the statistical information analysis site SI0 from the viewer terminal VT of the viewer, both the second data object information and third data object information are acquired. In this case, the viewing request indicates the selection of third data object information and second data object information as the data source.

The fourth data object information acquisition unit 233 acquires the fourth data object information of one or more fourth data objects included in one or more third data objects corresponding to one or more pieces of the third data object information, based on the fourth data object ID (or the simplified ID) associated with each of the plurality of fourth data object information stored in the fourth data object information database 121 and one or more pieces of the third data object information acquired by the third data object information acquiring unit 231. For example, the fourth data object information acquisition unit 233 extracts one or more fourth data object IDs (or the simplified IDs) from one or more pieces of the third data object information acquired by the third data object information acquisition unit 231. Then, the fourth data object information acquisition unit 233 transmits a request including the extracted one or more fourth data object IDs (or the simplified IDs) to the fourth data object statistical information server SE3. As a result, the fourth data object information acquisition unit 233 acquires one or more pieces of the fourth data object information associated with one or more fourth data object IDs (or the simplified IDs) from the fourth data object statistical information server SE3.

Moreover, the fourth data object information acquisition unit 233 acquires the fourth data object information of one or more fourth data objects included in one or more customers corresponding to one or more pieces of the second data object information, based on the email address associated with each of the plurality of fourth data object information stored in the fourth data object information database 121 and one or more pieces of the second data object information acquired by the second data object information acquisition unit 232. For example, the fourth data object information acquisition unit 233 extracts one or more email addresses from one or more pieces of the second data object information acquired by the second data object information acquisition unit 232. Then, the fourth data object information acquisition unit 233 transmits a request including the extracted one or more email address to the fourth data object statistical information server SE3. As a result, the fourth data object information acquisition unit 233 acquires one or more pieces of the fourth data object information associated with the one or more email addresses from the fourth data object statistical information server SE3. Incidentally, a request including one or more phone numbers or names instead of the email addresses, may be transmitted to the fourth data object statistical information server SE3. In this case, one or more pieces of the fourth data object information associated with the one or more phone numbers or the names may be acquired from the fourth data object statistical information server SE3.

Incidentally, in case where both the second data object information and the third data object information are acquired, the fourth data object information acquisition unit 233 may transmit a request including one or more email addresses acquired from the second data object information and one or more fourth data object IDs (or simplified IDs) acquired from the third data object information to the fourth data object statistical information server SE3. In this case, the fourth data object information associated with the email address and the fourth data object information associated with the fourth data object ID (or simplified ID) may be acquired from the fourth data object statistical information server SE3. However, if multiple duplicates of the fourth data object information of the same fourth data object are acquired, only one instance of the duplicate fourth data object information may be retrieved.

The attribute item designation receiving unit 234 receives the designation (i.e., the designation by the viewer) of one or more attribute items indicated in the first attribute item designation information or the second attribute item designation information from the viewer terminal VT of the viewer logged in using the second fifth data object ID. The one or more attribute items designated by the viewer (which may be a combination of multiple types of attribute items) are utilized as the grouping condition for grouping the fourth data objects, as described above.

As a result, the fourth data objects can be grouped with respect to one or more attribute items arbitrarily designated by the viewer.

With respect to one or more attribute items that have been set by default or those designated by the viewer, the grouping unit 235 classifies, based on the attributes of each of the plurality of fourth data objects whose fourth data object information has been acquired by the fourth data object information acquisition unit 233, the plurality of fourth data objects into one of the plurality of groups. That is, the grouping unit 235 groups the fourth data objects into distinct groups based on the grouping condition. Here, the attributes of the fourth data object are attributes indicated for each attribute item in the attribute information included in the fourth data object information acquired by the fourth data object information acquisition unit 233. Moreover, with respect to the specific attribute item designated by the viewer, the grouping unit 235 regroups, based on the attributes of each of the plurality of fourth data objects whose fourth data object information has been acquired by the fourth data object information acquisition unit 233, the grouped (classified) groups, as described above.

The statistical information generating unit 236 generates the statistical information based on the fourth data object information acquired by the fourth data object information acquisition unit 233. For example, the ratio of the total fourth data object count to the third data object count or second data object count is calculated, and the statistical information indicating the calculated ratio is generated. This makes it possible to present to the viewer the extent to which the fourth data object of the first fifth data object is included among the third data objects to the second fifth data object or the customers of the second fifth data object. Moreover, in case where the fourth data objects are grouped by the grouping unit 235, the statistical information generating unit 236 generates the statistical information on each of the grouped groups. This makes it possible to present to the viewer the statistical information on each group that is grouped with respect to one or more attribute items.

For example, the ratio of the group fourth data object count to the total fourth data object count is calculated, and the statistical information indicating the calculated ratio is generated for each group. Moreover, in case where the groups are regrouped, the statistical information generating unit 236 generates the statistical information on each of the regrouped groups.

The display limitation determining unit 237 determines whether the number (i.e., third data object count) of pieces of the third data object information acquired by the third data object information acquisition unit 231 or the number (i.e., second data object count) of pieces of the second data object information acquired by the second data object information acquisition unit 232 is equal to or less than the first threshold value. Incidentally, it may be determined whether the sum (excluding overlapping parts) of the third data object count and second data object count is equal to or less than the first threshold value. Moreover, the display limitation determining unit 237 may determine whether the number (i.e., total fourth data object count) of pieces of the fourth data object information acquired by the fourth data object information acquisition unit 233 is equal to or less than the second threshold value.

Here, in case where the fourth data objects are grouped by the grouping unit 235, the display limitation determining unit 237 may determine whether the group fourth data object count is equal to or less than the second threshold value for each of the grouped groups. Moreover, in case where the fourth data objects are regrouped by the grouping unit 235, the display limitation determining unit 237 may determine whether the group fourth data object count is equal to or less than the second threshold value for each of the regrouped groups.

When it is determined by the display limitation determining unit 237 that the third data object count or second data object count (alternatively, the sum of the third data object count and second data object count) is greater than the first threshold value, the display control unit 238 causes the statistical information generated by the statistical information generating unit 236 to be displayed on the statistical information display screen of the viewer terminal VT. Alternatively, when it is determined by the display limitation determining unit 237 that the total fourth data object count is greater than the second threshold value, the display control unit 238 causes the statistical information generated by the statistical information generating unit 236 to be displayed on the statistical information display screen of the viewer terminal VT.

Moreover, when it is determined by the display limitation determining unit 237 that the group fourth data object count is greater than the second threshold value, the display control unit 238 may cause the statistical information on a group whose group fourth data object count is greater than the second threshold value to be displayed on the statistical information display screen.

Here, if there are multiple groups whose group fourth data object count is greater than the second threshold value, the display control unit 238 may cause at least one of the Up Arrow Mark M1 and the Down Arrow Mark M2 to be displayed in association with the statistical information. The Up Arrow Mark M1 and the Down Arrow Mark M2 are marks for highlighting the statistical information according to the difference between the corresponding groups of numerical values represented by the displayed statistical information. This makes it possible to present the difference between the numerical values represented by the statistical information of each of the plurality of groups in an easy-to-understand visual manner.

Incidentally, displaying statistical information on the statistical information display screen of the viewer terminal VT is performed by the display control unit 238 transmitting display control data including the statistical information to the viewer terminal VT via the communication unit 21 and the statistical information analysis site SI0. Namely, the display control unit 238 controls the viewing terminal VT, by transmitting the display control data to the viewer terminal VT, such that the statistical information is displayed on the display device of the viewer terminal VT. The display control data may be included in the web page with statistical information and transmitted. Moreover, displaying the Up Arrow Mark M1 and the Down Arrow Mark M2 on the statistical information display screen of the viewer terminal VT is performed by the display control unit 238 transmitting display control data including data of the Mark M1, M2 to the viewer terminal VT via the communication unit 21 and the statistical information analysis site SI0.

On the other hand, when it is determined by the display limitation determining unit 237 that the third data object count or second data object count (alternatively, the sum of the third data object count and second data object count) is equal to or less than the first threshold value, the display control unit 238 executes a display limitation processing to limit the display of at least a portion of the statistical information based on the fourth data object information acquired by the fourth data object information acquisition unit 233. That is, the display control unit 238 executes the display limitation processing such that the display of at least the portion of the statistical information is limited on the display device of the viewing terminal VT. In such display limitation processing, the display control unit 238 transmits display control data for limiting the display of at least the portion of the statistical information based on the fourth data object information to the viewer terminal VT via the communication unit 21 and the statistical information analysis site SI0. This allows the statistical information based on the fourth data object information to be either concealed or blurred on the display device of the viewer terminal VT, for example, as shown in FIG. 9, thereby enabling more appropriate protection of information on the privacy of fourth data objects. Namely, the display control unit 238 controls the viewing terminal VT, by transmitting the display control data to the viewer terminal VT, such that the display of at least the portion of the statistical information is limited on the display device of the viewer terminal VT.

Alternatively, when it is determined by the display limitation determining unit 237 that the total fourth data object count is equal to or less than the second threshold value, the display control unit 238 may execute the display limitation processing to limit the display of at least a portion of the statistical information based on the fourth data object information acquired by the fourth data object information acquisition unit 233. Moreover, when it is determined by the display limitation determining unit 237 that the group fourth data object count is equal to or less than the second threshold value, the display control unit 238 executes the display limitation processing to limit the display of at least a portion of the statistical information on one or more groups whose group fourth data object count is equal to or less than the second threshold value. This allows the statistical information on such group to be either concealed or blurred on the display device of the viewer terminal VT, as shown in FIG. 10, thereby enabling more appropriate protection of information on the privacy of fourth data objects belonging to such group.

Incidentally, the display control unit 238 may determine whether the data source selected by the viewer is the second data object information (i.e., whether the selection of second data object information is indicated as the data source in the viewing request) or the third data object information. In this case, only when determining that the selected data source is the second data object information, the display control unit 238 executes the display limitation processing to limit the display of at least a portion of the statistical information based on the fourth data object information in response to the second data object count being equal to or less than the first threshold value or the fourth data object count included in the second data object count being equal to or less than the second threshold value. That is, in this case, when determining that the selected data source is the third data object information, the display control unit 238 does not execute the display limitation processing to limit the display of at least a portion of the statistical information based on the fourth data object information regardless of whether the third data object count is equal to or less than the first threshold value or whether the fourth data object count included in the third data object count is equal to or less than the second threshold value. This is because it is difficult to identify individuals when the data source is the third data object information.

### [2. Operation of Statistical Information Providing System S]

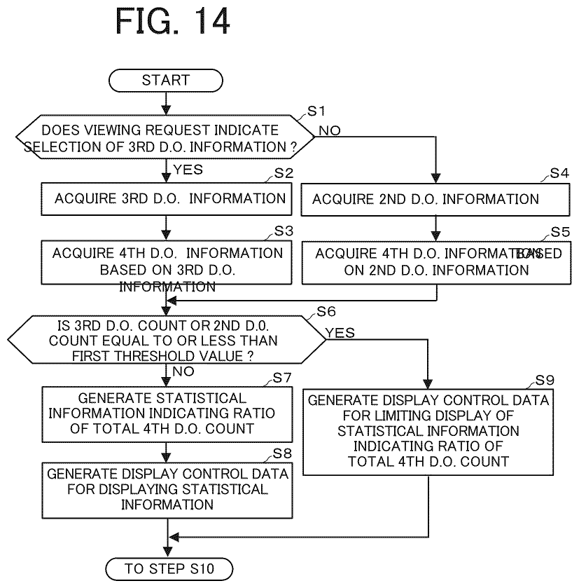

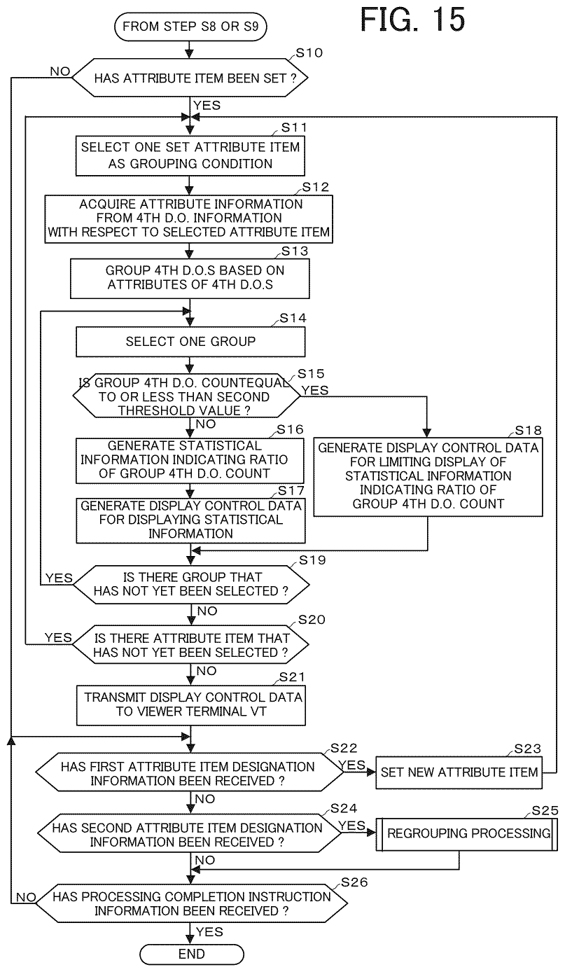

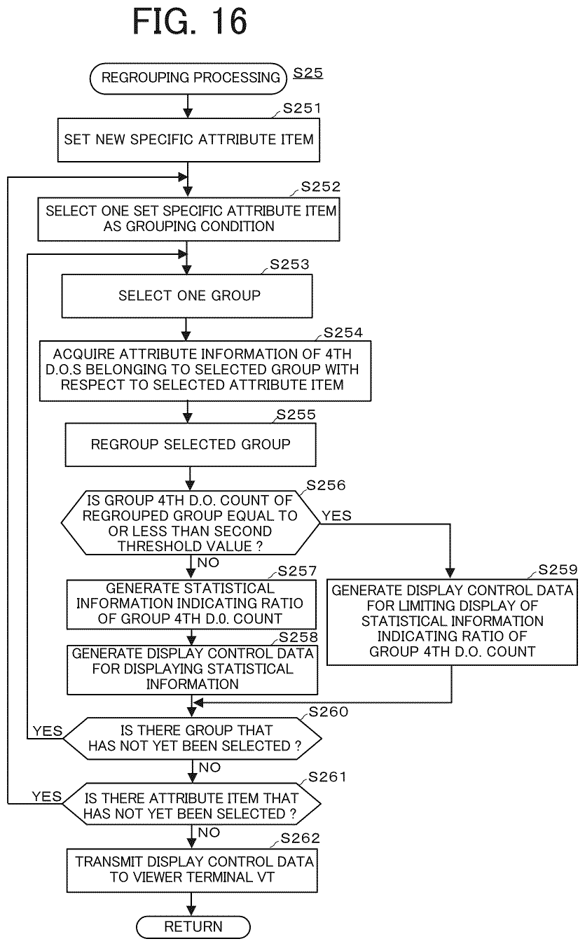

Next, an operation of the statistical information providing system S will be described with reference to FIGS. 14 to 16. FIGS. 14 and 15 are flowcharts illustrating an example of statistical information display processing executed by the control unit 23 of the statistical information providing server SE2. FIG. 16 is a flowchart illustrating an example of regrouping processing in step S25, as shown in FIG. 15. Incidentally, as a premise of the following description of the operation example, the viewer using the viewer terminal VT is logged in using the second fifth data object ID, and the display device of the viewer terminal VT displays the statistical information display screen for the second fifth data object corresponding to the second fifth data object ID. However, the statistical information is not yet be displayed on the statistical information display screen.

Once an instruction to select the button for generating statistical information is issued by the viewer on the statistical information display screen, the data source selection screen Sc1 illustrated in FIG. 3 is displayed as a popup. On the data source selection screen Sc1, once an instruction to select the Next Button B10 is issued while the Radio Button B11 in the Third data object Information Selection Area Ar11 is selected by the viewer, the viewing request indicating the selection of third data object information as the data source is transmitted from the viewer terminal VT to the statistical information providing server SE2 via the statistical information analysis site SI0.

Alternatively, on the data source selection screen Sc1, once an instruction to select the Next Button B10 is issued while the Radio Button B12 in the Second data object Information Selection Area Ar12 is selected, the second data object information upload screen is displayed. Then, once an instruction to select the submit button is issued after the second data object information list is designated through the second data object information upload screen, the viewing request indicating the selection of second data object information as the data source is transmitted, along with the designated second data object information list, from the viewer terminal VT to the statistical information providing server SE2 via the statistical information analysis site SI0. Incidentally, the received viewing request may also indicate the selection of third data object information and second data object information, as described above.

And then, once the viewing request transmitted from the viewer terminal VT is received by the statistical information providing server SE2, the statistical information display processing illustrated in FIG. 14. is started. The processing illustrated in FIG. 14 is started, the control unit 23 of the statistical information providing server SE2 determines whether the received viewing request indicates the selection of third data object (D.O.) information (step S1). When it is determined that the received viewing request indicates the selection of third data object information (step S1: YES), the process proceeds to step S2. Incidentally, even if the received viewing request indicates third data object information and second data object information, the process proceeds to step S2. On the other hand, when it is determined that the received viewing request does not indicate the selection of third data object information (i.e., the selection of second data object information is indicated) (step S1: NO), the processing proceeds to step S4.

In step S2, the control unit 23 acquires, by the third data object information acquisition unit 231, the third data object information associated with the second fifth data object ID from the third data object information database 221 in response to the received viewing request. The third data object information acquired in this way is deployed in the RAM. Next, the control unit 23 acquires, based on the third data object information acquired in step S2, the fourth data object information of one or more fourth data objects included in the third data objects (e.g., five fourth data objects included in the ten third data objects) from the fourth data object statistical information server SE3 (step S3), and the process proceeds to step S6.

For example, the fourth data object information acquisition unit 233 extracts the fourth data object ID (or simplified ID) from the third data object information acquired in step S2 and transmits the request including the extracted fourth data object ID (or simplified ID) to the fourth data object statistical information server SE3, thereby acquiring the fourth data object information associated with the extracted fourth data object ID (or simplified ID) from the fourth data object statistical information server SE3. The fourth data object information acquired in this way is deployed in the RAM.

On the other hand, in step S4, the control unit 23 acquires, by the second data object information acquisition unit 232, the second data object information from the received second data object information list in response to the received viewing request. The second data object information acquired in this way is deployed in the RAM. Next, the control unit 23 acquires the fourth data object information of one or more fourth data objects included in the customers from the fourth data object statistical information server SE3 based on the second data object information acquired in step S4 (step S5), and proceeds to step S6.

For example, the fourth data object information acquisition unit 233 extracts the email address from the second data object information acquired in step S4 and transmits the request including the extracted email address to the fourth data object statistical information server SE3, thereby acquiring the fourth data object information associated with the extracted email address from the fourth data object statistical information server SE3. The fourth data object information acquired in this way is deployed in the RAM.

Incidentally, if the received viewing request indicates the selection of third data object information and second data object information, the control unit 23 acquires the second data object information in addition to the third data object information in step S2, and subsequently acquires the fourth data object information of one or more fourth data objects in step S3 based on the fourth data object ID included in the third data object information and the email address included in the second data object information.

In step S6, the control unit 23 determines, by the display limitation determining unit 237, whether the number of pieces of the third data object information acquired in step S2 (i.e., the third data object count) or the number of pieces of second data object information acquired in step S4 (i.e., the second data object count) is equal to or less than the first threshold value. Incidentally, it may be determined whether the sum (excluding overlapping parts) of the third data object count and second data object count is equal to or less than the first threshold value. When it is determined that the third data object count or second data object count (alternatively, the sum of the third data object count and second data object count) is greater than the first threshold value (step S6: NO), the process proceeds to step S7.

On the other hand, when it is determined that the third data object count or second data object count (alternatively, the sum of the third data object count and second data object count) is equal to or less than the first threshold value (step S6: YES), the process proceeds to step S9. Incidentally, in step S6, the display limitation determining unit 237 may determine whether the number of pieces of fourth data object information acquired in step S3 or step S5 (i.e., total fourth data object count) is equal to or less than the second threshold value. In this case, when it is determined that total fourth data object count is greater than the second threshold value, the process proceeds to step S7. On the other hand, when it is determined that the total fourth data object count is equal to or less than the second threshold value, the process proceeds to step S9.

In step S7, the control unit 23 calculates the ratio of the total fourth data object count to the third data object count or second data object count and generates, by the statistical information generating unit 236, the statistical information indicating the calculated ratio. Incidentally, the statistical information generating unit 236 may calculate the ratio of the total fourth data object count to the sum (excluding overlapping parts) of the third data object count and second data object count, and generate the statistical information indicating the calculated ratio. Next, the control unit 23 generates, by the display control unit 238, display control data for displaying the statistical information generated in step S7 (step S8), and the process proceeds to step S10 shown in FIG. 15. Such display control data is set for transmission to the viewer terminal VT.

On the other hand, in step S9, the control unit 23 generates, by the display control unit 238, display control data for limiting the display of at least a portion of the statistical information indicating the ratio of the total fourth data object count to the third data object count or second data object count, and the process proceeds to step S10 shown in FIG. 15. Such display control data is set for transmission to the viewer terminal VT. Alternatively, the control unit 23 may transmit the display control data generated in step S9 to the viewer terminal VT via the statistical information analysis site SI0 and terminate the statistical information display processing illustrated in FIG. 14. Incidentally, in step S9, in case where the statistical information is to be concealed, the control unit 23 may generate display control data for displaying a message indicating that the statistical information cannot be displayed (i.e., the statistical information is not available), instead of generating the statistical information indicating the ratio of the total fourth data object count to the third data object count or second data object count.

Alternatively, in step S9, in case where the statistical information is to be concealed, the control unit 23 may generate the statistical information indicating the ratio of the total fourth data object count to the third data object count or second data object count, as well as display control data for overlaying a mask image on a display area of the generated statistical information. Alternatively, in step S9, in case where the statistical information is to be displayed ambiguously, the control unit 23 may generate the statistical information indicating the ratio of the total fourth data object count to the third data object count or second data object count, as well as display control data for displaying a numerical range that includes a numerical value represented by the statistical information while refraining from directly displaying the numerical value.

In step S10, the control unit 23 determines whether an attribute item has been set (i.e., whether an attribute item is being set). It may be determined whether a combination of multiple types of attribute items has been set. For example, when the residential area, gender, and generation are set as the attribute items by default, it is determined that the attribute items have been set (step S10: YES), and the process proceeds to step S11. On the other hand, when it is determined that the attribute item has not been set (step S10: NO), the process proceeds to step S22.

In step S11, the control unit 23 selects one set attribute item as the grouping condition. Incidentally, one combination of multiple types of attribute items may be selected. Next, with respect to the attribute item selected as the grouping condition in step S11, the control unit 23 acquires the attribute information indicating the attributes of fourth data objects from each of the plurality of fourth data object information acquired in step S3 or step S5 (step S12).

Next, the control unit 23 groups, by the grouping unit 235, the plurality of fourth data objects, based on the attributes indicated by each of the attribute information acquired in step S12 (step S13). In this way, each grouped group is assigned the group ID specific to that group.

Next, the control unit 23 selects one group that is grouped in step S13 (step S14). Next, the control unit 23 determines whether the group fourth data object count of the group selected in step S14 is equal to or less than the second threshold value (step S15). When it is determined that the group fourth data object count of the group is greater than the second threshold value (step S15: NO), the process proceeds to step S16. On the other hand, when it is determined that the group fourth data object count of the group is equal to or less than the second threshold value (step S15: YES), the process proceeds to step S18.

In step S16, the control unit 23 calculates the ratio of the group fourth data object count (i.e., the number of fourth data objects belonging to the group selected in step S14) to the total fourth data object count. Then, the control unit 23 generates, by the statistical information generating unit 236, the statistical information indicating the calculated ratio. That is, the statistical information on the selected group is generated. Next, the control unit 23 generates, by the display control unit 238, display control data for displaying the statistical information generated in step S16 (step S17), and the process proceeds to step S19. Such display control data includes the group ID of the selected group and is set for transmission to the viewer terminal VT.

In step S18, the control unit 23 generates, by the display control unit 238, display control data for limiting the display of at least a portion of the statistical information indicating the ratio of the group fourth data object count (i.e., the number of fourth data objects belonging to the group selected in step S14) to the total fourth data object count, and the process proceeds to step S19. Such display control data includes the group ID of the selected group and is set for transmission to the viewer terminal VT. Incidentally, in step S18, in case where the statistical information is to be concealed, the control unit 23 may generate display control data for displaying a message indicating that the statistical information cannot be displayed, instead of generating the statistical information indicating the ratio of the group fourth data object count to the total fourth data object count.

Alternatively, in step S18, in case where the statistical information is to be concealed, the control unit 23 may generate the statistical information indicating the ratio of the group fourth data object count to the total fourth data object count, as well as display control data for overlaying a mask image on a display area of the generated statistical information. Alternatively, in step S18, in case where the statistical information is to be displayed ambiguously, the control unit 23 may generate the statistical information indicating the ratio of the group fourth data object count to the total fourth data object count, as well as display control data for displaying a numerical range that includes a numerical value represented by the statistical information while refraining from directly displaying the numerical value.

In step S19, the control unit 23 determines whether there is a group that has not yet been selected among the groups that is grouped in step S13. When it is determined that there is the group that has not yet been selected (step S19: YES), the process returns to step S14. As a result, the group that has not yet been selected is selected, and the process of step S15 and the steps thereafter are executed for the selected group. On the other hand, when it is determined that there is no group that has not yet been selected (step S19: NO), the process proceeds to step S20.

In step S20, the control unit 23 determines whether there is an attribute item that has not yet been selected as the grouping condition among the set attribute items. When it is determined that there is the attribute item that has not yet been selected (step S20: YES), the process returns to step S11. As a result, the attribute item that has not yet been selected is selected as the grouping condition, and the process of step S12 and the steps thereafter are executed for the selected attribute item. On the other hand, when it is determined that there is no attribute item that has not yet been selected (step S20: NO), the process proceeds to step S21.

In step S21, the control unit 23 transmits, by the display control unit 238, the display control data (i.e., the display control data set for transmission) generated in at least any one of step S8, step S9, step S17, and step S18 to the viewer terminal VT via the statistical information analysis site SI0, and the process proceeds to step S22.

Here, the process for transmitting the display control data generated in step S9 to the viewer terminal VT via the statistical information analysis site SI0 is an example of the display limitation processing described above. Through this processing, for example, as illustrated in FIG. 9, the display of the statistical information indicating the ratio of the total fourth data object count to the third data object count or second data object count is limited in the Second data object Data Coverage Area Ar21 on the statistical information display screen of the viewer terminal VT. Moreover, the process for transmitting the display control data generated in step S18 to the viewer terminal VT via the statistical information analysis site SI0 is an example of the display limitation processing described above. Through this processing, for example, as illustrated in FIG. 10, the display of the statistical information on the group of men in their 30s is limited in the Demographic Area Ar24 on the statistical information display screen of the viewer terminal VT.

In step S22, the control unit 23 determines whether the first attribute item designation information from the viewer terminal VT has been received. When it is determined that the first attribute item designation information has been received (step S22: YES), the designation of the attribute item (or the combination of multiple types of attribute items) indicated in the first attribute item designation information is received by the attribute item designation receiving unit 234, and the process proceeds to step S23. On the other hand, when it is determined that the first attribute item designation information has not been received (step S22: NO), the process proceeds to step S24.

In step S23, the control unit 23 newly sets the attribute item (or the combination of multiple types of attribute items) indicated in the first attribute item designation information received in step S22 and the process returns to step S11. Returning to step S11, one newly set attribute item (or the combination of multiple types of attribute items) is selected as the grouping condition, and the process of step S12 and the steps thereafter are executed for the selected attribute item (or the combination of multiple types of attribute items).

In step S24, the control unit 23 determines whether the second attribute item designation information from the viewer terminal VT has been received. When it is determined that the second attribute item designation information has been received (Step S24: YES), the designation of the specific attribute item (or the combination of multiple types of specific attribute items) indicated in the second attribute item designation information is received by the attribute item designation receiving unit 234, and the process proceeds to step S25. On the other hand, when it is determined that the second attribute item designation information has not been received (step S24: NO), the process proceeds to step S26.

In step S25, the regrouping processing is executed. As illustrated in FIG. 16, the control unit 23 newly sets the specific attribute item (or the combination of multiple types of attribute items) indicated in the second attribute item designation information received in step S24 (step S251). Next, the control unit 23 selects one specific attribute item (or the combination of multiple types of attribute items) set in step S251 as the grouping condition (step S252).

Next, the control unit 23 selects one group identified by any one group ID of the plurality of group IDs indicated in the second attribute item designation information received in step S24 (step S253). Next, with respect to the attribute item selected as the grouping condition in step S252, the control unit 23 acquires the attribute information indicating the attributes of fourth data objects belonging to the group selected in step S253 (i.e., acquires from the above-acquired fourth data object information) (step S254).

Next, the control unit 23 regroups, by the grouping unit 235, the selected group based on the attributes indicated by the attribute information acquired in step S254 (step S255).

Next, the control unit 23 determines whether the group fourth data object count of the group regrouped in step S255 is equal to or less than the second threshold value (step S256). When it is determined that the group fourth data object count is greater than the second threshold value (step S256: NO), the process proceeds to step S257. On the other hand, when it is determined that the group fourth data object count is equal to or less than the second threshold value (step S256: YES), the process proceeds to step S259.

In step S257, the control unit 23 calculates the ratio of the group fourth data object count to the total fourth data object count and generates, by the statistical information generating unit 236, the statistical information indicating the calculated ratio.

Next, the control unit 23 generates, by the display control unit 238, display control data for displaying the statistical information generated in step S257 (step S258), and the process proceeds to step S260. Such display control data is set for transmission to the viewer terminal VT.

In step S259, the control unit 23 generates, by the display control unit 238, display control data for limiting the display of at least a portion of the statistical information indicating the ratio of the group fourth data object count to the total fourth data object count, and the process proceeds to step S260. Such display control data is set for transmission to the viewer terminal VT.

In step S260, the control unit 23 determines whether there is a group that has not yet been selected. When it is determined that there is the group that has not yet been selected (step S260: YES), the process returns to step S253. As a result, the group that has not yet been selected is selected, and the process of step S254 and the steps thereafter are executed for the selected group. On the other hand, when it is determined that there is no group that has not yet been selected (step S260: NO), the process proceeds to step S261.

In step S261, the control unit 23 determines whether there is an attribute item that has not yet been selected. When it is determined that there is the attribute item that has not yet been selected (step S261: YES), the process returns to step S252. As a result, the attribute item that has not yet been selected is selected as the grouping condition, and the process of step S253 and the steps thereafter are executed for the selected attribute item. On the other hand, when it is determined that there is no attribute item that has not yet been selected (step S261: NO), the process proceeds to step S262.

In step S262, the control unit 23 transmits, by the display control unit 238, the display control data (i.e., display control data set for transmission) generated in at least any one of step S258 and step S259 to the viewer terminal VT via the statistical information analysis site SI0, and the process proceeds to step S26 shown in FIG. 15. Here, the process of transmitting the display control data generated in step S259 to the viewer terminal VT via the statistical information analysis site SI0 is an example of the display limitation processing described above.

In step S26, the control unit 23 determines whether the processing completion instruction information from the viewer terminal VT has been received. Such processing completion instruction information is, for example, information transmitted from the viewer terminal VT to the statistical information providing server SE2 via the statistical information analysis site SI0 when a processing completion instruction is given by the viewer. When it is determined that the processing completion instruction information from the viewer terminal VT has not been received (step S26: NO), the process returns to step S22. On the other hand, when it is determined that the processing completion instruction information from the viewer terminal VT has been received (step S26: YES), the statistical information display processing illustrated in FIGS. 14 and 15 ends.

As described above, according to the above embodiment, in response to the viewing request from the viewer of the second fifth data object, the statistical information providing server SE2 acquires third data object information of the third data object to the second fifth data object site SI2 or second data object information of the second data object of the second fifth data object, and acquires fourth data object information of the fourth data objects of the first fifth data object based on the acquired third data object information or second data object information. Then, the statistical information providing server SE2 executes the display limitation processing to limit the display of at least a portion of the statistical information based on the fourth data object information in response to the third data object count or second data object count being equal to or less than the first threshold value, or the fourth data object count being equal to or less than the second threshold value. Therefore, when the statistical information based on the fourth data object information of the fourth data objects to be analyzed is presented to the viewer, it is possible to more appropriately protect information on the privacy of the fourth data objects. Accordingly, it is possible to prevent exposure of privileged data associated with fourth data objects, even if the number of pieces of the acquired fourth data object information is very small.

Moreover, according to the above embodiment, it is possible to protect privileged information associated with data objects belonging to one or more groups whose fourth data object count is equal to or less than the second threshold value, while simultaneously presenting the statistical information on groups whose number of fourth data objects greater than the second threshold value to viewer. Furthermore, according to the above embodiment, in a case where the statistical information based on the fourth data object information of one or more fourth data objects of the first fifth data object is presented to the viewer of the second fifth data object among the third data objects or customers who can use the service by the second fifth data object in response to the viewing request by the viewer of the second fifth data object, it is possible to more appropriately protect privileged information associated with the fourth data objects.

Incidentally, the above embodiment is one embodiment of the present disclosure, and the present disclosure is not limited to the above-described embodiment, changes from the above-described embodiment can be made on various configurations and the like within a scope not departing from the gist of the present disclosure, and such cases shall be also included in the technical scope of the present disclosure. The statistical information providing system S according to the above embodiment can also be used for analysis of fourth data objects within the first fifth data object. In this case, in response to the viewing request from the viewer of the first fifth data object, the statistical information providing server SE2 acquires third data object information of the third data object to the first fifth data object site SI1 or second data object information of the second data object of the first fifth data object, and acquires fourth data object information of the fourth data objects of the first fifth data object based on the acquired third data object information or second data object information. Then, the statistical information providing server SE2 executes the display limitation processing to limit the display of at least a portion of the statistical information based on the fourth data object information in response to the third data object count or second data object count being equal to or less than the first threshold value, or the fourth data object count being equal to or less than the second threshold value.

Moreover, in the above embodiment, the case where the statistical information providing server SE2 is taken as an example as the computer architecture of the present disclosure has been described. However, the computer architecture of the present disclosure may be set up so that the viewer terminal VT (as an example of the computer architecture) accesses the statistical information providing server SE2 and the fourth data object statistical information server SE3 through the statistical information analysis site SI0 to utilize the database. In this case, the control unit 5 of the viewer terminal VT functions as the third data object information acquisition unit 231, second data object information acquisition unit 232, fourth data object information acquisition unit 233, attribute item designation receiving unit 234, grouping unit 235, statistical information generating unit 236, display limitation determining unit 237, display control unit 238, etc. in cooperation with the statistical information providing server SE2 and the fourth data object statistical information server SE3 via the statistical information analysis site SI0. This enables the control unit 5 of the viewer terminal VT to execute the processing illustrated in FIGS. 14 to 16. Moreover, in the above embodiment, although an example was shown in which the second data object information includes an email address, a telephone number, etc., the second data object information may be configured to include second information (for example, the simplified ID, etc.) other than the email address, etc.

### <Note>

[1] A computer architecture according to the present disclosure is capable of utilizing a database that stores fourth data object information associated with first information of one or more first data objects registered through a predetermined fourth data object registration procedure, and capable of displaying statistical information based on the fourth data object information on a display device. The computer architecture includes: an information acquisition unit configured to acquire second information of one or more second first data objects who can use a predetermined service, the one or more second first data objects including one or more first data objects, in response to a viewing request from a viewer to view the statistical information; a fourth data object information acquisition unit configured to acquire the fourth data object information of the one or more first data objects included in the one or more second first data objects, based on the first information associated with the fourth data object information stored in the database and the second information acquired by the information acquisition unit; and a display control unit configured to execute a display limitation processing to limit, on the display device, display of at least a portion of the statistical information based on the fourth data object information acquired by the fourth data object information acquisition unit, in response to the number of pieces of the second information acquired by the information acquisition unit being equal to or less than a first threshold value, or the number of pieces of the fourth data object information acquired by the fourth data object information acquisition unit being equal to or less than a second threshold value. This makes it possible to more appropriately protect information on the privacy of the first data objects (e.g., fourth data objects).

[2] In the computer architecture described in [1] above, the one or more first data objects may be registered through the fourth data object registration procedure performed by a first provider, and the one or more second first data objects may be able to use a service provided by a second provider. The information acquisition unit may be further configured to acquire the second information of the one or more second first data objects, in response to the viewing request from a viewing terminal used by the viewer belonging to the second provider, and the display control unit may be further configured to execute the display limitation processing such that the display of at least the portion of the statistical information based on the fourth data object information acquired by the fourth data object information acquisition unit is limited on the display device of the viewing terminal. Accordingly, in a case where the statistical information based on the fourth data object information of the first data objects of the first provider among the second first data objects who can use the service by the second provider is presented to the viewer of the second provider in response to the viewing request by the viewer of the second operator, it is possible more appropriately protect information on the privacy of the first data objects.

[3] In the computer architecture described in [1] or [2] above, the statistical information may include a ratio of the number of pieces of the fourth data object information to the number of pieces of the second information. This makes it possible to present to the viewer the extent to which the first data objects are included among the second first data objects who can use the predetermined service.

[4] In the computer architecture described in [2] or [3] above, a first browser of a first data object terminal used by the first data object may store cookie information including the first information. The cookie information may be issued by a server of the first provider when the first data object terminal accesses a first website of the first provider via a communication network by the first browser. A second browser of a second first data object terminal used by the second first data object may execute a script set on a second website of the second provider in response to the second first data object terminal accessing the second website via the communication network by the second browser. Third data object information indicating that the second first data object has visited the second website may be transmitted to the server via the communication network by executing the script. If the cookie information including the first information has stored in the second browser of the second first data object terminal used by the second first data object as the first data object, the third data object information including the cookie information may be transmitted to the server via the communication network. The information acquisition unit may be further configured to acquire, as the second information, the first information included in the cookie information transmitted to the server. This makes it possible for the first provider to appropriately identify the number of third data objects to the second website through the script set on the second website.

[5] In the computer architecture described in [4] above, the statistical information may include a ratio of the number of pieces of the fourth data object information to the number of pieces of the third data object information. This makes it possible to present to the viewer of the second provider the extent to which the first data objects are included among the third data objects to the second website.

[6] In the computer architecture described in any one of to [5] above, the fourth data object information may include transaction information indicating a history of one or more transactions of the first data object in a business of the first provider, and the statistical information may be based on the transaction information included in the fourth data object information acquired by the fourth data object information acquisition unit. This makes it possible to present the statistical information based on the transaction information of the first data objects in the business of the first provider to the viewer of the second provider.

[7] In the computer architecture described in any one of to [6] above, the fourth data object information may include attribute information indicating one or more attributes of the first data object with respect to one or more predefined attribute items. The computer architecture may further include: a grouping unit configured to classify a plurality of the first data objects into one of a plurality of groups, based on at least one attribute of each of the plurality of first data objects whose fourth data object information has been acquired by the fourth data object information acquisition unit; and a statistical information generating unit configured to generate the statistical information on each of the plurality of groups. This makes it possible to present to the viewer the statistical information on each group that is classified with respect to the predefined attribute item.

[8] In the computer architecture described in [7] above, the fourth data object information may include attribute information indicating one or more attributes of the first data object with respect to each of a plurality of the attribute items. The computer architecture may further include a designation receiving unit configured to receive a designation of one or more attribute items among the plurality of attribute items from the viewer With respect to the attribute item designated by the viewer, the grouping unit may be further configured to classify the plurality of first data objects into one of the plurality of groups, based on the attribute of each of the plurality of first data objects whose fourth data object information has been acquired by the fourth data object information acquisition unit. This makes it possible to classify the first data objects into one of the plurality of groups with respect to the attribute item arbitrarily designated by the viewer.

[9] In the computer architecture described in [7] or [8] above, the display control unit may be further configured to display the statistical information generated by the statistical information generating unit for a plurality of the groups whose number of pieces of the fourth data object information is greater than the second threshold value among the classified groups, and to display a mark for highlighting the statistical information in association with the statistical information according to a difference between a corresponding groups of numerical values represented by the displayed statistical information. This makes it possible to present the difference between the numerical values represented by the statistical information of each of the plurality of groups in an easy-to-understand visual manner.

[10] In the computer architecture described in any one of [7] to [9] above, the display control unit may be further configured to display the statistical information generated by the statistical information generating unit for the groups whose number of pieces of the fourth data object information is greater than the second threshold value among the classified groups, and to execute the display limitation processing to limit the display of the statistical information generated by the statistical information generating unit for one or more groups whose number of pieces the fourth data object information is equal to or less than the second threshold value. This makes it possible to protect information on the privacy of fourth data objects belonging to the group whose number of pieces of the fourth data object information is equal to or less than the second threshold value, while simultaneously presenting the statistical information on the group whose number of pieces of the fourth data object information is greater than the second threshold value to viewer.

[11] In the computer architecture described in any one of [1] to [10] above, the display control unit may be further configured to display, in the display limitation process, a numerical range that includes a numerical value represented by the statistical information while refraining from directly displaying the numerical value. This allows the viewer to gain some understanding of the statistical information based on the fourth data object information, while simultaneously more appropriately ensuring the protection of information on the privacy of the first data objects.

[12] In the computer architecture described in any one of [1] to [11] above, the display control unit may be further configured to execute a display limitation processing to limit the display of at least a portion of the statistical information based on the fourth data object information acquired by the fourth data object information acquisition unit, in response to the number of pieces of the second information acquired by the information acquisition unit being equal to or less than the first threshold value.

[13] In the computer architecture described in any one of [1] to [11] above, the display control unit may be further configured to execute a display limitation processing to limit the display of at least a portion of the statistical information based on the fourth data object information acquired by the fourth data object information acquisition unit, in response to the number of pieces of the fourth data object information acquired by the fourth data object information acquisition unit being equal to or less than the second threshold value.

[14] In the computer architecture described in [12] above, the display control unit may be further configured to generate display control data for displaying the statistical information and to control a viewing terminal used by the viewer, by transmitting the generated display control data to the viewing terminal via a communication network, such that the statistical information is displayed on the display device. In the display limitation processing, the display control unit may be further configured to determine whether the number of pieces of the second information is equal to or less than the first threshold value, to generate display control data for limiting the display of at least the portion of the statistical information, in response to determining that the number of pieces of the second information is equal to or less than the first threshold value, and to control the viewing terminal, by transmitting the generated display control data to the viewing terminal via the communication network, such that the display of at least the portion of the statistical information is limited on the display device.

[15] In the computer architecture described in [13] above, the display control unit may be further configured to generate display control data for displaying the statistical information and to control a viewing terminal used by the viewer, by transmitting the generated display control data to the viewing terminal via a communication network, such that the statistical information is displayed on the display device. In the display limitation processing, the display control unit may be further configured determine whether the number of pieces of the fourth data object information is equal to or less than the second threshold value, to generate display control data for limiting the display of at least the portion of the statistical information, in response to determining that the number of pieces of the fourth data object information is equal to or less than the second threshold value, and to control the viewing terminal, by transmitting the generated display control data to the viewing terminal via the communication network, such that the display of at least the portion of the statistical information is limited on the display device.

[16] A display control method executed by one or more computers, according to the present disclosure, includes: accessing a database that stores fourth data object information associated with first information of one or more first data objects registered through a predetermined fourth data object registration procedure; displaying statistical information based on the fourth data object information on a display device; acquiring second information of one or more second first data objects who can use a predetermined service, the one or more second first data objects including one or more first data objects, in response to a viewing request from a viewer to view the statistical information; acquiring the fourth data object information of the one or more first data objects included in the one or more second first data objects, based on the first information associated with the fourth data object information stored in the database and the acquired second information; and executing a display limitation processing to limit, on the display device, display of at least a portion of the statistical information based on the acquired fourth data object information, in response to the number of pieces of the acquired second information being equal to or less than a first threshold value, or the number of pieces of the acquired fourth data object information being equal to or less than a second threshold value.

[17] A program according to the present disclosure, is configured to cause a computer to: access a database that stores fourth data object information associated with first information of one or more first data objects registered through a predetermined fourth data object registration procedure; display statistical information based on the fourth data object information on a display device; acquire second information of one or more second first data objects who can use a predetermined service, the one or more second first data objects including one or more first data objects, in response to a viewing request from a viewer to view the statistical information; acquire the fourth data object information of the one or more first data objects included in the one or more second first data objects, based on the first information associated with the fourth data object information stored in the database and the acquired second information; and execute a display limitation processing to limit, on the display device, display of at least a portion of the statistical information based on the acquired fourth data object information, in response to the number of pieces of the acquired second information being equal to or less than a first threshold value, or the number of pieces of the acquired fourth data object information being equal to or less than a second threshold value.

### REFERENCE SIGNS LIST

1 Communication unit
2 Operation unit
3 Display unit
4 Storage unit
5 Control unit
11 Communication unit
12 Storage unit
13 Control unit
21 Communication unit
22 Storage unit
23 Control unit
121 Fourth data object information database
221 Third data object information database
222 Second data object information database
SE1 Fourth data object information management server
SE2 Statistical information providing server
SE3 Fourth data object statistical information server
SE4 Third data object statistical information server
SE5 Third data object information collection server
SE6 Fourth data object processing server
UTn First data object terminal
VT Viewer terminal
S Statistical information providing system

What is claimed is:

1. A computer architecture comprising:
a database that stores first data object information associated with first information of one or more second data objects registered through a predetermined first data object registration procedure;
a display device capable of displaying statistical information based on the first data object information on a display device:
at least one memory configured to store program code; and
at least one processor configured to access the program code and operate as instructed by the program code, the program code including:
information acquisition code configured to cause the at least one processor to acquire second information of one or more third data objects who can use a predetermined service, the one or more third data objects including one or more second data objects, in response to a viewing request from a viewer to view the statistical information;
first data object information acquisition code configured to cause the at least one processor to acquire the first data object information of the one or more second data objects included in the one or more third data objects, based on the first information associated with the first data object information stored in the database and the acquired second information; and
display control code configured to cause the at least one processor to execute a display limitation processing to limit, on the display device, display of at least a portion of the statistical information based on the acquired first data object information, in response to the number of pieces of the acquired second information being equal to or less than a first threshold value, or the number of pieces of the acquired first data object information being equal to or less than a second threshold value.

2. The computer architecture according to claim 1, wherein the one or more second data objects are registered through the first data object registration procedure performed by a first provider, and the one or more third data objects can use a service provided by a second provider, and
wherein the information acquisition code is configured to cause the at least one processor to acquire the second information of the one or more third data objects, in response to the viewing request from a viewing terminal used by the viewer belonging to the second provider, and the display control code is configured to cause the at least one processor to execute the display limitation processing such that the display of at least the portion of the statistical information based on the acquired first data object information is limited on the display device of the viewing terminal.

3. The computer architecture according to claim 2, wherein the statistical information includes a ratio of the number of pieces of the first data object information to the number of pieces of the second information.

4. The computer architecture according to claim 2, wherein a first browser of a second data object terminal used by the second data object stores cookie information including the first information, the cookie information being issued by a server of the first provider when the second data object terminal accesses a first website of the first provider via a communication network by the first browser,
wherein a second browser of a third data object terminal associated with the third data object executes a script set on a second website of the second provider in response to the second first data object terminal accessing the second website via the communication network by the second browser, fourth data object information indicating that the third data object is associated with a visit to the second website being transmitted to the server via the communication network by executing the script, and if the cookie information including the first information has stored in the second browser of the second first data object terminal used by the third data object as the second data object, the fourth data object information including the cookie information is transmitted to the server via the communication network, and
wherein the information acquisition code is configured to cause the at least one processor to acquire, as the second information, the first information included in the cookie information transmitted to the server.

5. The computer architecture according to claim 4, wherein the statistical information includes a ratio of the number of pieces of the first data object information to the number of pieces of the fourth data object information.

6. The computer architecture according to claim 2, wherein the first data object information includes transaction information indicating a history of one or more transactions of the second data object in a business of the first provider, and the statistical information is based on the transaction information included in the acquired first data object information.

7. The computer architecture according to claim 1, wherein the first data object information includes attribute information indicating one or more attributes of the second data object with respect to one or more predefined attribute items, and
wherein the program code further includes:
grouping code configured to cause the at least one processor to classify a plurality of the second data objects into one of a plurality of groups, based on at least one attribute of each of the plurality of second data objects whose first data object information has been acquired; and
statistical information generating code configured to cause the at least one processor to generate the statistical information on each of the plurality of groups.

8. The computer architecture according to claim 7, wherein the first data object information includes attribute information indicating one or more attributes of the second data object with respect to each of a plurality of the attribute items, and
wherein the program code further includes designation receiving code configured to cause the at least one processor to receive a designation of one or more attribute items among the plurality of attribute items from the viewer, and
the grouping code configured to cause the at least one processor to classify the plurality of second data objects into one of the plurality of groups, based on the attribute, with respect to the attribute item designated by the viewer, of each of the plurality of second data objects whose first data object information has been acquired.

9. The computer architecture according to claim 7, wherein the display control code is configured to cause the at least one processor to display the statistical information generated for a plurality of the groups whose number of pieces of the first data object information is greater than the second threshold value among the classified groups, and to display a mark for highlighting the statistical information in association with the statistical information according to a difference between a corresponding groups of numerical values represented by the displayed statistical information.

10. The computer architecture according to claim 7, wherein the display control code is configured to cause the at least one processor to display the statistical information generated for the groups whose number of pieces of the first data object information is greater than the second threshold value among the classified groups, and to execute the display limitation processing to limit the display of the statistical information generated for one or more groups whose number of pieces the first data object information is equal to or less than the second threshold value.

11. The computer architecture according to claim 1, wherein the display control code configured to cause the at least one processor to display, in the display limitation process, a numerical range that includes a numerical value represented by the statistical information while refraining from directly displaying the numerical value.

12. The computer architecture according to claim 1, wherein the display control code configured to cause the at least one processor to execute a display limitation processing to limit the display of at least a portion of the statistical information based on the acquired fourth data object information, in response to the number of pieces of the acquired second information being equal to or less than the first threshold value.

13. The computer architecture according to claim 1, wherein the display control code configured to cause the at least one processor to execute a display limitation processing to limit the display of at least a portion of the statistical information based on the acquired first data object information, in response to the number of pieces of the acquired first data object information being equal to or less than the second threshold value.

14. The computer architecture according to claim 12, wherein the display control code configured to cause the at least one processor to generate display control data for displaying the statistical information and to control a viewing terminal used by the viewer, by transmitting the generated display control data to the viewing terminal via a communication network, such that the statistical information is displayed on the display device, and
in the display limitation processing, the display control code configured to cause the at least one processor to determine whether the number of pieces of the second information is equal to or less than the first threshold value, to generate display control data for limiting the display of at least the portion of the statistical information, in response to determining that the number of pieces of the second information is equal to or less than the first threshold value, and to control the viewing terminal, by transmitting the generated display control data to the viewing terminal via the communication network, such that the display of at least the portion of the statistical information is limited on the display device.

15. The computer architecture according to claim 13, wherein the display control code configured to cause the at least one processor to generate display control data for displaying the statistical information and to control a viewing terminal used by the viewer, by transmitting the generated display control data to the viewing terminal via a communication network, such that the statistical information is displayed on the display device, and
in the display limitation processing, the display control code configured to cause the at least one processor to determine whether the number of pieces of the first data object information is equal to or less than the second threshold value, to generate display control data for limiting the display of at least the portion of the statistical information, in response to determining that the number of pieces of the first data object information is equal to or less than the second threshold value, and to control the viewing terminal, by transmitting the generated display control data to the viewing terminal via the communication network, such that the display of at least the portion of the statistical information is limited on the display device.

16. A display control method executed by one or more computers comprising:
accessing a database that stores first data object information associated with first information of one or more second data objects registered through a predetermined first data object registration procedure;
displaying statistical information based on the first data object information on a display device;
acquiring second information of one or more third data objects who can use a predetermined service, the one or more third data objects including one or more second data objects, in response to a viewing request from a viewer to view the statistical information;
acquiring the first data object information of the one or more second data objects included in the one or more third data objects, based on the first information associated with the first data object information stored in the database and the acquired second information; and
executing a display limitation processing to limit, on the display device, display of at least a portion of the statistical information based on the acquired first data object information, in response to the number of pieces of the acquired second information being equal to or less than a first threshold value, or the number of pieces of the acquired first data object information being equal to or less than a second threshold value.

17. A non-transitory computer-readable memory having stored thereon a program configured to cause a computer to:
access a database that stores first data object information associated with first information of one or more second data objects registered through a predetermined first data object registration procedure;
display statistical information based on the first data object information on a display device;
acquire second information of one or more third data objects who can use a predetermined service, the one or more third data objects including one or more second data objects, in response to a viewing request from a viewer to view the statistical information;
acquire the first data object information of the one or more second data objects included in the one or more third data objects, based on the first information associated with the first data object information stored in the database and the acquired second information; and
execute a display limitation processing to limit, on the display device, display of at least a portion of the statistical information based on the acquired first data object information, in response to the number of pieces of the acquired second information being equal to or less than a first threshold value, or the number of pieces of the acquired first data object information being equal to or less than a second threshold value.
